(19) United States
(12) Patent Application Publication
(10) Pub. No.: US 2012/0159534 A1
(43) Pub. Date: Jun. 21, 2012

(54) SIGNAL MODIFICATION VIA MEDIA GUIDANCE APPLICATION DATA AND/OR METADATA

(75) Inventors: Ronald Quan, Cupertino, CA (US); John F. Cloutman, Tracy, CA (US)

(73) Assignee: Rovi Technologies Corporation, Santa Clara, CA (US)

(21) Appl. No.: 13/163,520

(22) Filed: Jun. 17, 2011

Related U.S. Application Data
(60) Provisional application No. 61/362,643, filed on Jul. 8, 2010.

(51) Int. Cl. H04N 21/25

(52) U.S. Cl. 725/31

(57) ABSTRACT

Data for a programming guide or other type of media guidance application of the type associated with video, such as television Electronic Programming Guides (EPG) or Interactive Programming Guides (IPG), is transported via a digital delivery network such as the Internet to a video receiving or storage device such as a personal video recorder (PVR). The receiving device extracts one or more signals from the media guidance application data for a purpose such as programming of control signals. The receiving device thereby reads or interprets control signals derived from the programming guide data provided via the digital delivery network so as to control subsequent recording (or other storage) of the video programs or other video content assets associated with the media guidance application data.

### FIELD

This disclosure pertains to digital video, device control, and television.

### BACKGROUND

“Metadata” associated with video including a television programming guide which is an example of a media guidance application such as an Electronic Programming Guide (EPG) or an Interactive Program Guide (IPG) is transmitted via digital television (DTV) transmissions, Internet Protocol television (IPTV), and/or a digital video delivery network such as the Internet. The metadata may include information pertaining to video content or a video asset, e.g. asset identifier, title, video or television tuning or source selector information e.g., frequency, source, channels or sub channels, rating, e.g. parental control purposes such as locked out channels, closed caption data, and/or other data, e.g. control data for Video on Demand or pay programs such as Pay Per View.

Further relating to the field of video content control and/or device control for the well known NTSC, PAL, and SECAM standard color television systems, color picture information is transmitted on a subcarrier signal. In this case of the NTSC system the subcarrier signal has a frequency of about 3.58 MHz and in the case of the PAL system a frequency of about 4.43 MHz. In both systems the precise color at any point in the picture is determined by the phase of this subcarrier signal relative to some reference phase, while the degree of saturation of the color is determined by the amplitude of the subcarrier signal.

In order for a television receiver to correctly reproduce colors, the receiver requires information concerning the above-mentioned reference phase. This information is transmitted as part of the video signal in the form of a burst of about nine cycles of the subcarrier signal following the horizontal synchronization pulse, and is referred to as the color burst. This color burst in the television receiver phase-locks a crystal oscillator circuit, thus generating a continuous subcarrier signal at the reference phase which is then used to demodulate the color information. It is normal for the phase-locked crystal oscillator circuit in the television receiver to have a fairly long time constant, on the order of a few milliseconds. The long time constant insures that the crystal oscillator circuit will ignore short term phase perturbations of the color burst signal as might be caused by noise. This color burst has been used for NTSC etc. standard television to provide copy protection, as described below.

### SUMMARY

This application relates to commonly owned and invented U.S. application Ser. No. 12/749,225 filed Mar. 29, 2010 “Content Control via Guide Data and/or Metadata” incorporated herein by reference in its entirety.

Information transported or transmitted in the form of metadata or a portion of Interactive or Electronic Programming Guides (hereinafter referred to as programming guide) data as described above may be used to program, enable, or disable signals such as content control signals also as described above that are inserted or added to a video signal. Programming guides are examples of media guidance applications, also called media information guidance applications. One embodiment of the present invention utilizes such metadata and/or other information from programming guide signals or similar sources to subsequently command a digital Personal Video Recorder (PVR), which is an example of a digital video storage device, or provide (output) one or more types of video content control or record control signals. This metadata or programming guide also including an Electronic Service guide (ESG) or similar signal may be transported by way of the Internet or other digital delivery network (e.g. cable, DSL, radio frequency (RF), satellite, fiber optic, phone lines, wireless, Wi-Fi, WiMax, and/or the like). At least a portion of the metadata or programming guide signal is then coupled to a receiver. The receiver then extracts relevant data from the input signal to the receiver as metadata or programming guide information pertaining to control bits for enabling, disabling, and/or programming content control signal(s) or any combination of a content control signal and a copy protection signal. In an analog video signal, the metadata may be sent as pulses within one or more television lines in an overscan area, e.g. pulses in one or more portion of a vertical and/or horizontal blanking interval, or portion of a television line.

The present invention further relates to integrated circuits (ICs) of the type used in receiving (and/or playback or display) devices, which process signals from metadata, digital video stream, digital register, or a programming guide for enabling/disabling/programming content control signals. More particularly, the invention relates to an integrated circuit for use in receiving and/or playback or display devices, which include set top boxes, IP television (IPTV or Internet Protocol Television) devices, cell phones, digital media extending devices, which receive video programs via a digital signal, and/or integrated circuits that are used in such record and/or playback devices.

An integrated circuit or system in accordance with the invention receives a bit pattern from metadata, digital video stream, digital register, or a programming guide signal. For example, such a bit pattern is coupled to a circuit to provide a content control command to a recorder or to a processing circuit to generate a content control signal. In particular the bit pattern may be utilized in a manner to program, enable, or disable the generated control signal.

One embodiment of the invention provides an integrated circuit that may be used in a video signal receiver, which may include a set top box, computer, recorder, playback device, display, cell phone, Internet Protocol television device, or the like, to output a “new” content control signal which is normally playable on a television set or video display. This integrated circuit may include an encoder for providing a modified video signal with one or more content control signals and/or a detector or reader, or both encoder and reader. The reader or detector may sense certain modifications to a video signal, which may include one or more content control signals.

One embodiment of the invention includes a detector for a phase modulated signal, wherein the input of the detector receives a phase modulated signal and wherein the output of the detector confirms a minimum amount of phase modulation to provide a logical “true” or 1 signal. In this example, the logical true signal may indicate the presence of phase modulation. The output of the phase detector may be coupled to a recorder or a device to provide content control of video signals, or to provide a video signal with one or more modifications or added signals. For example, the reception of a phase modulated signal may provide or program added signals or signals inserted in a video signal, or the reception of a phase modulated signal may provide a subsequent command to a compliant device such as a recording, playback, receiving, and/or display device. An exemplary command may include: restricted duration of recording, restricted viewing period, prohibited recording or viewing, altered video/audio quality for display and/or recording.

Another embodiment of the invention includes an apparatus for programming or enabling or disabling a content control signal derived from a metadata, or programming guide signal including: a circuit to receive a metadata, or programming guide signal from a digital delivery network, wherein the metadata or programming guide signal includes a trigger or flag signal or bit pattern signal, further including coupling the trigger, flag, and/or bit pattern signal to a processing circuit and/or an encoding circuit to provide programming, enabling, or disabling the content control signal at an output of the encoding circuit, wherein the content control signal is added or inserted to a video signal to provide a content controlled video signal and wherein the content controlled video signal provides resistance to a circumvention device.

U.S. Pat. No. 5,479,268 to Young et al, issued Dec. 26, 1995 and US Patent Application Publication US 2003/0149980 Hassell et al. published Aug. 7, 2003 pertain to programming guides such as EPG (Electronic Programming Guide) and IPG (Interactive Programming Guide), and are both incorporated by reference here in their entireties. An exemplary programming guide which may be provided or derived via an IPG or EPG signal, is for example a method or apparatus allowing a user to select one or more (favorite) video channels (sources) and includes providing to a display, e.g., via a screen, a number of cells representing a corresponding number of video channels available for viewing by a user, where each cell includes a channel number and/or a program (video asset) service name for a particular channel. Assets here include television programs, movies, portions of programs or movies and other video material such as brief videos or video clips, but this is not limiting. The user uses the display to select a channel among the number of channels; for example, changing a status of the selected channel to that of a favorite channel in response to the user selection, or displaying in cells corresponding to the favorite channels a visual indication that the selected channels are favorite channels, and providing program guide information for the subset of channels having said favorite status in response to a user indication to view the program guide information.

Another example of a programming guide, which is derived from a programming guide signal and which is exemplary of a media guidance application referred to above, includes a method or apparatus for navigating about a television or video listing or other type of asset identifier including one or more steps of: storing in electronic or computer readable memory (storage) a number of television or video program listings (asset identifiers); each listing including title, telecast time, and/or channel (source); displaying on a monitor screen some of the titles of the program listings in a grid format of time and channel; moving a cursor or other indicator on the screen to mark one or more of the displayed titles in the grid guide format; opening to the marked title in a single or multiple format, which may be instead be of the (original) grid guide format, where the single channel format includes rows (or columns) of sequential television or video program listings for the channel (or other source) corresponding to the marked title; additionally including moving the indicator on the screen to mark a different displayed title in the single channel format; where the storing step stores programming listings and/or the displaying step displays simultaneously with the program listings the program notes corresponding to the marked title.

Such a grid pattern or cell may include straight or curved segments. Alternatively, a two dimensional grid pattern may be transformed to a three dimensional grid pattern or vice versa. Such a grid pattern may include three and/or two dimensional properties. For example, one cell to another cell in the programming guide may be represented in a curved surface and/or a solid object's sides. Cells may be of regular and/or irregular shape(s).

One embodiment of the invention provides an integrated circuit that may be used in a receiver, which may include a set top box, computer, cell phone, Internet Protocol television device, or the like, to output a “new” content control signal which is normally playable on a television set. For example this integrated circuit may receive control bit(s) to enable and/or to program one or more waveforms for content control (or for copy protection). The control bit(s) or bit pattern may be derived from a programming guide transmission, and/or a recorded medium or storage, e.g., an Electronic Control Message signal, memory device, DVD, BluRay, CD, System Operator, bit command or default bit pattern in a media player and/or media receiver. For example, the control bit or bit pattern may be used in providing/programming/controlling a phase modulated waveform in a video signal, e.g., phase modulated or phase shift keying waveform to synthesize a signal in one or more horizontal blanking intervals including “m” number of cycles of a first phase angle, and/or a “n” number of cycles of a second phase angle; where “m”=“n” or “m”<“n” or “m”>“n”.

This disclosure further relates to commonly owned and invented U.S. application Ser. No. 12/563,050 filed Sep. 18, 2009, hereby incorporated by reference in its entirety, and in particular to the well known Macrovision Corp. (now Rovi Corp.) “color stripe” (CS) process which is detected by specially provided signal detectors of the type often embedded in commercially available integrated chip sets used in video recorders (storage devices) or other Rovi Corp. compliant video devices. It is known that such a color stripe detector is able to read or detect properly the Rovi Corp. color stripe copy protection signals when an entire video color burst as described above is phase modified or when a majority of the color burst is so phase modified. In one embodiment of the invention there is provided a color stripe-type content control signal or record control signal that is detectable by a standard PVR (personal video recorder) while essentially not providing any chroma (color) copy protection signal, by providing a weakened color stripe different from the usual color stripe signal.

The usual color stripe signal, known from Ryan U.S. Pat. No. 4,577,216 incorporated herein by reference in its entirety, is primarily a copy protection video signal, which is generally playable on a television set, but which causes an analog recording video cassette recorder (VCR) to play back a recorded signal with color errors. In the PAL television system, synthesizing a playable color stripe signal with negligible display artifacts while providing an effective copy protection signal on a VCR or other video tape recorder is a challenge. For example, the more effective the color stripe signal is on a particular video tape recorder in preventing copying, the more likely that undesirable playability artifacts on a television display are noticeable. Some PAL color stripe processes therefore are not commercially viable because of such display artifacts, and thus not implemented.

In recent years with the decline in VCR sales and usage, newer video recorders such as digital Personal Video Recorders have replaced the older VHS (analog) video tape recorders also referred to as VCRs. These digital video recorders use a different type of recording system, which generally includes a color stripe detector as explained above for reading or detecting the incoming color stripe signal. Once a color stripe copy protection signal is detected in a video signal, a content control command is generated by the detector, such as “Prohibit Recording/Viewing”. A “compliant” digital video recorder can then accept the content control command to stop recording or to replace/mute the program video signal with another signal such as a blue screen. Brill et al., U.S. Pat. No. 6,600,873, incorporated herein by reference in its entirety, discloses how a compliant device such as a video recorder includes special detection circuit to detect the color stripe signal and producing in response a control signal which disables the recorder, to prevent further recording. The same concept is embodied in commercially available integrated circuit video decoders which detect the color stripe signal and in response issue commands to control operation (such as no recording) of a compliant device such as a video set top box, personal video recorder or other in which the video decoder is installed. Such video decoders are generally referred to in the field as “Macrovision compliant”. Examples are the Texas Instruments televisionP5146 video decoder and the Micronas AVF4910B video pixel decoder. See also Rovi Corp. patent publication WO 2005/039176A1 disclosing use of analog copy protection to encode permitted use information, incorporated herein by reference in its entirety.

It is also known to provide a modified or weakened color stripe signal that is so detectable, but is not necessarily effective as a copy protection signal on a VHS video tape recorder or other video tape recorder. Ryan U.S. Pat. No. 4,626,890 and Quan et al. U.S. Pat. No. 5,784,523 both incorporated by reference in their entirety, further show ways to defeat the effects of color stripe signals by removing the incorrect phase in at least a portion or the whole of a color burst envelope. Normally one would conclude that by modifying a color stripe signal so as to defeat its color copy protection effects, the color stripe signal would also be not detectable in a compliant content control system by a detector. But it has been found that one or more color stripe “defeat” aspects of Quan et al. U.S. Pat. No. 5,784,523 can be applied to improve playability of a video signal on a television display set while defeating color stripe copy protection effects on a video tape recorder and still allowing color stripe detection in a compliant device, e.g. to cause the compliant device to prevent recording; see U.S. application Ser. No. 12/350,740, filed Jun. 8, 2009, Cloutman et al., incorporated by reference in its entirety.

The present disclosure further pertains to video receivers and tuners that play video received from an external source and produce there from an analog video signal output which includes a weakened or defeated form of the color stripe process. These receivers and tuners play such video which also may include anti-copy bit(s) or signal flag(s), which when detected in the receiver or tuner, applies an appropriate analog (e.g., color stripe) content control signal. In prior implementations, receivers provided copy protection signals that were effective on downstream video recorders such as tape recorders. However, with the decline in use of analog VHS and other video tape recorders which are typically VCRs and increased use of digital recorders, such copy protection signals for analog video tape recorders become less useful. To provide an effective copy protection signal for any video recorder, playability must be taken into consideration. So generally those copy protection signals most effective on a VCR are not provided commercially because of playability problems. Thus, for a commercial process, an effective copy protection signal generally must minimize playability artifacts. Thus prior receivers or tuners provide an effective copy protection video signal while being acceptable in playability, and while being very effective on a downstream compliant content control device. A compliant content control device reads and/or senses the copy protection signal and provides commands to shut down the recorder, to limit recording use, etc. as explained above. However, an “effective” copy protection signal generally is “overkill” for such a compliant device. Thus, a “weakened” or “defeated” copy protection signal will provide optimal video playability while still providing effective content control in a compliant device, without regard to copy protection effectiveness on a “non-compliant” VCR. One such copy protection signal is the color stripe signal described above, and a variant of the color stripe modified color burst signal is used in embodiments disclosed here.

The “weakened” color stripe signal as described here may be combined with other video copy protection signal modifications such as AGC and/or pseudo synchronization pulses in a portion of the horizontal and/or vertical blanking interval, lowered portion of the front and/or back porch of a video signal, lowered portion of an active field of the videos signal, e.g., included lowered portion of one or more television lines of the program video signal, and/or lowered portion of one or more television lines of any letter boxed region, or bordered region, and/or synchronization modifications in amplitude, position, and/or width.

In one embodiment a video tuner or receiver in accordance with the invention receives from an external source a digital video signal or video file which includes, e.g., Analog Protection System (APS), bit(s) or other control bit(s) (data or information) and couples the digital video signal to a reader or bit detector also part of the tuner or receiver e.g., for Analog Protection System, control, mode, and/or configuration of content control signal. The output signal of the reader or bit detector is coupled to a generator or a programmable generator in the tuner or receiver to provide a response to the weakened color stripe signal, which is generally not effective for copy protection on a downstream non-compliant VCR but is effective when detected by a compliant downstream content control device or other compliant apparatus, e.g., an analog to digital converter, PVR and/or video display. Depending on the output of the sensing circuit or reader, the weakened color stripe signal may be enabled, disabled or modified. The weakened color stripe signal generally is synthesized in the tuner or receiver by a digital to analog converter and/or encoder circuit and for example, coupled to the analog video output terminal of the tuner or receiver for transmission to the downstream device.

Note that a tuner or receiver in accordance with the invention may be (or may be incorporated in) a television set, set top box, a mobile telephone, a PVR, a VCR, a network hub, wireless router, a modem, a storage unit linked to a network or a transmission, an Internet Protocol television device, and/or a computer with network access, e.g., via Ethernet, wireless, and/or optical link.

In one embodiment, the tuner or receiver is a digital set top box device which receives a digital video signal by coupling to a transmitted or streamed source, which is coupled to a digital to analog converter (DAC) and/or encoder, wherein a generator or programmable generator is coupled to or part of the encoder and/or Digital to Analog Converter, and wherein the output of the digital to analog converter provides the weakened color stripe signal to, e.g., a television set. In this embodiment, no control bit or Analog Protection System bit is required or needs to be read to activate the weakened color stripe signal applied at the analog output terminal of the tuner or receiver.

In another embodiment, the tuner or receiver outputs the weakened color stripe signal in video signals also including program content that conform to, e.g., the 240p, 480I, 576I, PALN, PALNC, PALM, PAL, and/or NTSC television standards but this is not limiting. The tuner or receiver may insert or add into the output video signals copy conventional protection waveforms which are, e.g., Analog Gain Control (AGC) pulses, AGC and pseudo synchronization (pseudo synchronization) pulse pair signals, lowered portion of back porch, lowered portion of front porch, lower portion of one or more lines in the active television field. The tuner or receiver, e.g., being a modification of a conventional DVD player or Blu-Ray player, when switched to the 1080I television standard and/or to a progressive television standard such as 480p, 576p, 720p, and/or 1080p, provides pseudo synchronization and/or AGC pulses, or positive going pulses in the vertical and/or horizontal blanking intervals in selected television scan lines via a Digital to Analog Converter, pulse generator, and/or encoder circuit.

In yet another embodiment of the tuner or receiver, a waveform signal generator circuit in the tuner or receiver provides waveforms including pseudo synchronization and/or horizontal synchronization pulses in a position, pulse-width, and/or amplitude modulated manner combined with a circuit or generator that synthesizes the weakened color burst signal.

Such tuners or receivers which output a weakened color stripe signal may further include conventional circuit and software and mechanisms to play conventional digital media such as CDs, DVDs, Blu-Ray discs, High Definition-DVD discs, video tape, magnetic disk, and/or solid state memory devices. Examples of the tuner or receiver may thus include modified DVD players, Blu-Ray players, hard disc players, video tape players, and/or Uniform Serial Bus (USB) accessible solid state memory, built in solid state memory, and/or flash memory players, where the memory devices can be internal and/or externally accessed. In some tuners or receivers, a combination to two or more readers or players may be present such as a video tape player in combination with a Blu-Ray or DVD player or memory device player. Such tuners or receivers may include a television tuner and/or demodulator, but not necessarily. For instance, Internet based devices such as certain mobile telephones, some Blu-Ray DVD players, and computers cannot generally receive cable or broadcast or satellite television video signals, but can receive video files over the Internet, and are a type of Internet Protocol television receiver. All such devices are generally referred to here as a tuner or receiver or video receiver apparatus.

Some such tuners or receivers allow for external coupling via a USB or IEEE1394 or similar connection, e.g., Ethernet, for receiving a digital video program from an external source (not necessarily a television transmission), which when converted to an analog video signal include the weakened color stripe signal. Another embodiment of the tuner or receiver includes an external memory connection (e.g., USB or FireWire IEEE1394), Local Area Network (LAN), and/or Ethernet to modify or update any of the analog copy protection waveforms mentioned while allowing the tuner or receiver to include at its analog video signal output a weakened color stripe signal. In yet another embodiment the tuner or receiver may reside in a computer and/or a display, which outputs an analog video output signal that includes a weakened color stripe signal.

The present modified or “weakened” also referred here to as “defeated” color stripe signal, e.g., as providing a content control signal or record control signal, may also be combined with other well known analog video copy protection waveforms such as pseudo synchronization and/or AGC pulses. Also, one may combine the weakened color stripe signal with other copy protection methods such as synchronization narrowing, level shifting a portion of the video signal such as a lowered portion of a front or back porch region or an active field, e.g., when compared to another portion of the video signal such as a portion of the vertical blanking interval.

One may generate two or more types of defeated or weakened color stripe signals such that when combined with other waveforms, different types or levels of copy protection can be identified such as the well known Rovi Corp. Type 2 or Type 3 or Type n. A Type n copy protection signal can be linked to the well known Analog Protection System) trigger bits that are used in tuners or receivers such as those built into some DVD players, and/or cable or satellite television set top boxes or the like.

The tuner or receiver may provide a weakened color stripe signal that is detectable by a detection system, but does not have appreciable color copy protection effectiveness on a non-compliant video tape recorder.

The tuner or receiver may provide a weakened color stripe signal color burst modification which also has an extended color burst envelope. For example, a normal color burst includes about 8 to 10 cycles of subcarrier frequency, e.g., 4.43 MHz. Embodiments of the invention include greater than 10 cycles of subcarrier for the color burst modification.

The tuner or receiver generally may include more subcarrier cycles of substantially normal phase than cycles of incorrect phase in the weakened color stripe signal, e.g., the color stripe signal is reduced or weakened in providing the above described color copy protection effects to a PAL standard video tape recorder. In Wrobleski et al. U.S. Pat. No. 6,516,132 incorporated by reference in its entirety, a color stripe signal with improved playability but which is copy prevention effective is provided having at least equal or more in number of subcarrier cycles of incorrect phase compared to the number of subcarrier cycles of correct or normal phase. Commercially available color stripe detectors, as referred to above, by design detect this type of color stripe signal. In one example, in U.S. Pat. No. 6,516,132 two cycles of added incorrect phase form an extended color stripe color burst envelope to provide an effective color copy protection signal to a VCR, and to afford detection by such color stripe detectors.

Embodiments thus utilize color stripe modifications of the general type shown in U.S. Pat. No. 6,516,132 where segmented (or partial color burst modifications provide a reduced or defeated or weakened copy protection effect by generally providing a color burst with fewer cycles of incorrect color burst phase than those with correct or normal phase. One or more of this weakened type of color burst modifications is detectable by a commercially available color stripe reader/detector as described above. In an example, two subcarrier cycles of normal (correct) phase are added to the color burst to form an extended color stripe color burst envelope to provide reduced or defeated color copy protection effectiveness on a VCR, and also to still provide color stripe detection for content control purposes.

For example, in one version of a “defeated” color stripe PAL signal, e.g., a two video line color stripe color burst signal with more cycles of normal phase than incorrect phase, which was recorded, negligible color stripe effects were observed upon playback of the video by a VHS type VCR. Yet this “defeated” color stripe PAL signal was detected successfully as a color stripe signal by an available Rovi Corp. compliant video decoder.

The present weakened or defeated color stripe signal may be combined with any known copy protection enhancement signal, e.g., level shifting a portion of the video signal or any waveform described in Wonfor et al. U.S. Pat. No. 5,583,936 incorporated by reference in its entirety, any part of a basic copy protection signal such as AGC and/or pseudo synchronization pulses, and/or any modification in one or more synchronization signals, e.g., synchronization pulse amplitude, synchronization pulse level shifting, synchronization pulse width modification, and/or synchronization pulse position modification.

### BRIEF DESCRIPTION OF THE DRAWINGS

FIG. 1A shows in the prior art an effective copy protection color stripe signal as a waveform.

FIG. 1B shows in the prior art a copy protection effective split burst or segmented color stripe signal as a waveform.

FIG. 1C shows in the prior art another effective split burst copy protection signal as a waveform.

FIGS. 2A and 2B show “defeated” color stripe signals used in accordance with the invention as waveforms.

FIGS. 2C to 2F show additional defeated color stripe signals as waveforms.

FIG. 3 shows a prior art color burst of normal phase and modified duration as a waveform.

FIG. 4 shows a color stripe detector in a block diagram in accordance with the invention.

FIG. 5 shows a generic Macrovision Corp. compliant device in a block diagram which senses one or more video signal modifications.

FIG. 6A shows an example in a block diagram of a system operator enabling or controlling one or more video signals in accordance with the invention.

FIG. 6B shows an example in a block diagram of a playback or receiving device enabling, controlling, or providing one or more waveforms in accordance with the invention.

FIG. 7A shows an apparatus in a block diagram to provide one or more waveforms in accordance with the invention.

FIG. 7B shows another apparatus in a block diagram to synthesize or provide one or more waveforms in accordance with the invention.

FIG. 8 shows an apparatus in a block diagram to provide one or more waveforms (and/or one or more basic copy protection signals or enhancement signals).

FIG. 9 shows detail of an apparatus in a block diagram as in FIG. 4 to detect waveforms in accordance with the invention.

FIGS. 10, 11, 12, 13, and 14 each shows an example in a block diagram of a tuner or receiver which outputs the present record or content control and/or copy protection signals.

FIGS. 15 and 16 show diagrammatically systems including the present tuner or receiver.

FIG. 17 shows in a block diagram a receiver which is a set top box.

FIG. 18A shows in a block diagram an apparatus for sensing copy protection or content control signals.

FIG. 18B shows in a block diagram a variant of the FIG. 18A apparatus.

FIG. 18C shows in a block diagram yet another variant of the FIG. 18A apparatus.

FIG. 19 shows in a block diagram an exemplary user equipment apparatus.

FIG. 20 shows diagrammatically an exemplary user delivery system for a programming guide.

FIG. 21 shows an illustrative programming guide display screen.

### DETAILED DESCRIPTION

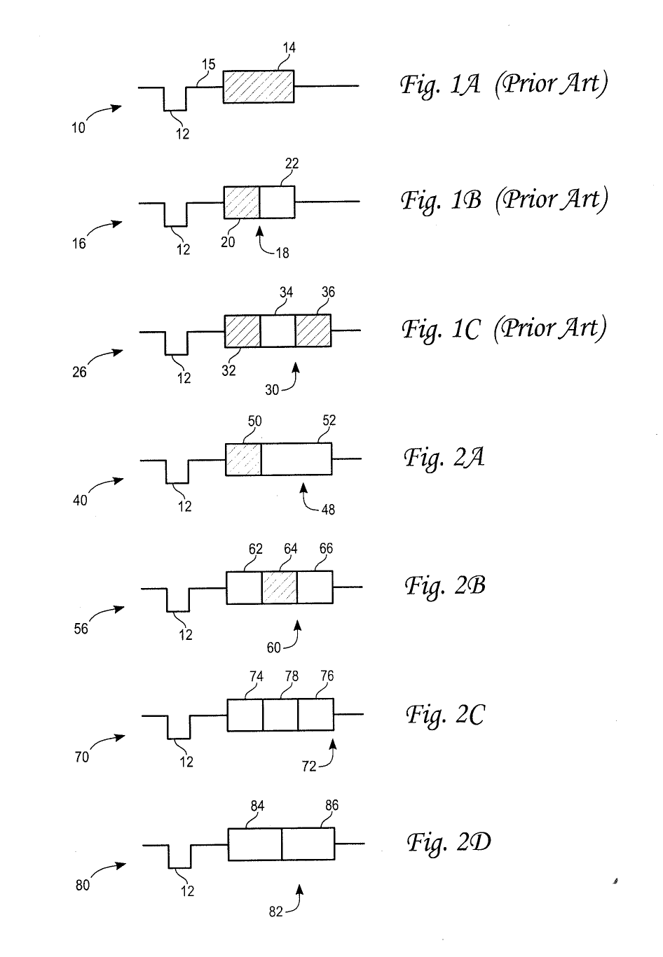

FIG. 1A shows a prior art video waveform 10 which is a mostly conventional television horizontal blanking interval having horizontal synchronization pulse 12, color burst 14 and breezeway 15 but wherein 8 to 10 subcarrier cycles of the color burst 14 indicated by the hatching are modified in phase to about 180 degrees from the normal or correct phase. Conventionally the horizontal axis is time and the vertical axis voltage also called amplitude. Ryan U.S. Pat. No. 4,577,216 incorporated herein by reference in its entirety teaches that a number of horizontal lines of a video signal with this type of modified color burst 14 yields effective copy protection when applied to a video tape recorder. The hatched color burst 14 denotes the incorrect or modified phase which is also referred to as phase angle such as a departure of 180 degrees from the normal color burst phase angle of zero degrees of a color video signal for these subcarrier cycles.

FIG. 1B, also showing a prior art waveform 16, is a variation of FIG. 1A in which at least half the cycles of an entire color burst envelope 18 are shifted so as to have an incorrect burst phase. In this example, the color burst envelope 18 is a “split” or segmented color burst illustrated as a hatched portion 20 of incorrect phase and a second portion 22 of correct phase. For an effective copy protection signal to produce noticeable color distortion when recorded by a VCR, at least half of the total burst envelope 18 duration is modified to the incorrect phase 20. For example, the duration of the hatched incorrect portion 20 is equal or greater than the correct portion 22 in burst envelope 18. Such a waveform may also include an extended color burst envelope 18 wherein cycles of preferably incorrect phase start ahead of a normal color burst envelope, as explained below.

FIG. 1C shows another variation of FIG. 1A, which provides an effective in terms of copy prevention color copy protection signal 26 to a video recorder. In this example, the color burst envelope 30 is segmented or split into three or more portions 32, 34, and 36. Again, the hatched areas 32, 36 denote incorrect color burst phase while middle portion 34 denotes normal color burst phase. In general, as long as there are more subcarrier cycles of incorrect phase than normal or correct color phase, the modified color burst 30 provides an effective copy protection signal. Here the total duration or number of subcarrier cycles of the portions 32, 36 is greater or equal than the middle portion 34 to provide an effective color stripe signal.

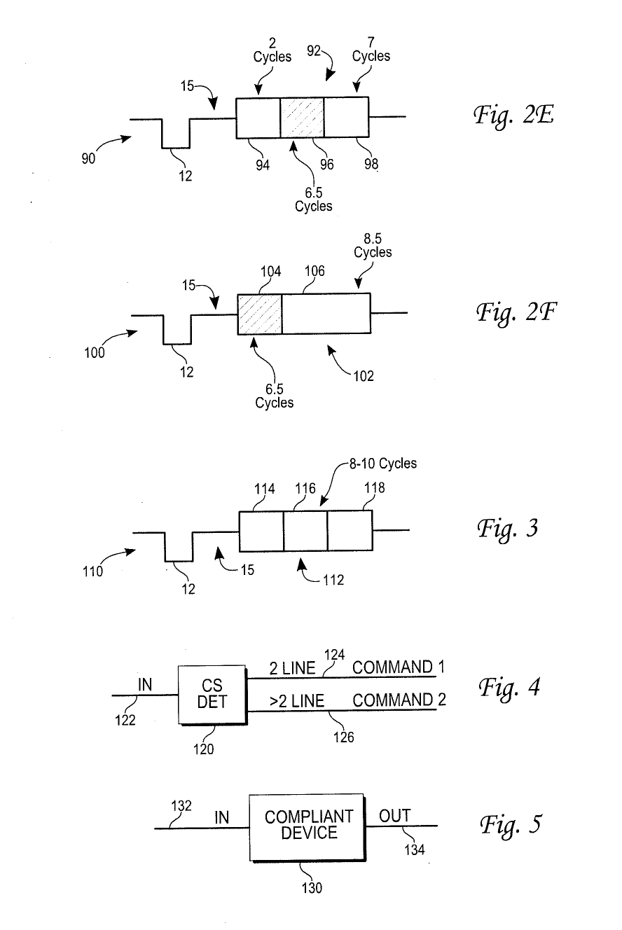

FIG. 2A illustrates a weakened color stripe waveform 40 used in an embodiment of the invention. FIGS. 2A to 9 are the same as in U.S. application Ser. No. 12/350,740. Here modified color burst 48 has fewer cycles of incorrect phase angle in section 50 than cycles of correct phase angle in section 52. While this type of modified burst 48 is disclosed in Quan et al. as a way to defeat or reduce copy protection effectiveness or to improve on playability effects, the present inventors have found that this “defeated” or weakened color stripe signal is still detectable by commercially available color stripe detectors of the type described above.

Although the color stripe incorrect phase angle may be in the range of 20 degrees to 180 degrees, normal phase angle being 0 degrees, in some examples a phase of about 180 degrees for the incorrect burst phase portion is preferable to a smaller phase shift. For example, in some PAL television displays such as television sets or monitors, providing a modified phase of 90 degrees causes more noticeable playability artifacts than a modified phase of 180 degrees. When choosing an incorrect subcarrier phase from 20 to 180 degrees, intuitively it would seem that a phase angle less than 180 degrees would cause less playability artifacts also called display problems. Thus it would seem that 90 degrees of phase shift would cause fewer display problems than 180 degrees of phase shift. Experimentally, it has been found that 180 degrees of phase shift for a color stripe burst, whether for a weakened or effective copy protection color stripe, actually causes less or fewer display artifacts than a 90 degree phase shifted color burst. So preferably, a weakened version of the color stripe here has in one embodiment 180 degrees of phase shift.

In another variation of such a defeated or reduced effectiveness copy protection signal, FIG. 2B shows a video signal 56 having a modified color burst 60, which as in FIG. 1C is a segmented color burst. In this example of three segments 62, 64, 64 in the modified color burst signal 60, the number of incorrect phase subcarrier cycles is again less that the total number of correct phase subcarrier cycles. For example, the summed duration of the first and third segments 62, 66 with normal phase angle subcarrier cycles exceeds the middle segment's 64 duration, wherein the middle segment 64 includes the incorrect phase angle cycles.

FIG. 2C shows a video signal 70 having a weakened and segmented color burst 72 wherein incorrect phase angle color burst subcarrier cycles are in segments 74, 76, and/or 78, and wherein correct phase angle color burst phase subcarrier cycles are in modified color burst segments 74, 76, and/or 78 such that there are more subcarrier cycles of correct phase angle than incorrect phase angle. In some instances, the segment(s) that would include correct phase angle cycles may be blanked or attenuated. In other instances, the cycles of incorrect phase angle may have a lower amplitude level/magnitude than the correct phase angle cycles. Hence in an embodiment of the invention, it is possible to have more subcarrier cycles of incorrect phase angle than subcarrier cycles of correct phase angle, provided that one or more incorrect phase angle subcarrier cycles is sufficiently attenuated, e.g., reduced in amplitude, or blanked.

For example in general, the modified color burst 72 may include segments 74, 76, 78 with set or programmed amplitude, position, and/or phase angle. This means that each segment or section can be programmed in terms of amplitude, position or phase switch point, and/or phase angle such as 180 degrees. Color burst 72 represents a generic signal that can be provided in any Macrovision Corp. compliant, also called certified, integrated circuit for DVD players, etc.

Similarly, in FIG. 2D for a video signal 80 having a two segment modified color burst 82, there are segments 84, 86. The position and/or duration of segments 84, 86 may be defined. This means that the phase transition or phase switch point in the split burst may be moved or varied in position, and that number or subcarrier cycles within each segment may be set to a specific number or cycles to provide a duration in each section of the modified color burst signal. So in one embodiment as described above, segment 84 may include “M” number of cycles of incorrect phase angle followed by segment 86 with “N” number of cycles of correct phase angle or vice versa, where preferably, N>M. Segment 84 or 50, 62, or 74 may include cycles of subcarrier advanced or before the start of a normal burst envelope, e.g., include cycles of subcarrier in at least a portion of a breezeway after a trailing edge of a synchronization pulse or modified synchronization pulse. It should be noted that the breezeway 15 in FIGS. 2E, 2F, and/or 3 may be a gap width between 0 microsecond and about 2 microseconds. For example, when breezeway 15 is close to 0 microsecond, cycles of subcarrier correct or incorrect phase/frequency would start immediately after synchronization pulse 12's trailing edge. FIGS. 2E and 2F are specific examples of the weakened color stripe signal, whereas FIGS. 2C and 2D are general examples.

FIG. 2E shows an embodiment similar to that of FIGS. 2A to 2D for PAL (or NTSC) television standard video. For a video signal horizontal blanking interval 90 having a 4 or more line (per band) colorstripe signal in color burst 92, in segment 94 two cycles of normal phase angle are followed by a segment 96 having 6.5 cycles of incorrect phase angle, followed by segment 98 with 7 cycles of correct phase angle. Note that the number of cycles per color burst may be varied within +/−10%. Here segment 94 may extend into the breezeway 15.

FIG. 2F shows another embodiment for PAL or NTSC television standard video for a video signal 100 having color burst 102 wherein a two or more horizontal line per band color stripe signal has 6.5 subcarrier cycles of incorrect phase angle in segment 104 extending into the breezeway 15 followed by 8.5 cycles of correct phase angle in segment 106. Note again that the number of cycles may vary within +/−10%. Here segment 104 may extend into the breezeway 15.

FIG. 3 shows for video signal 110 an extended color burst 112 with segment 116 having correct phase angle, wherein a segment 114 of several cycles of correct phase angle is added in the breezeway area 15 and a segment 118 is added extending after the normal burst envelope 116 for at least some of the non-color stripe television horizontal lines, in accordance with the invention. By extending the duration of the burst envelope with correct phase angle, playability may be improved. For instance, when combined with colorstripe signals that have extended burst duration, color burst duration may be extended, e.g., with cycles of incorrect and/or correct phase angle in the examples of FIG. 2A, 2B, 2E or 2F.

FIG. 4 shows a generic example of a color stripe (CS) detector 120 which senses color stripe waveforms in accordance with the invention which are applied at input terminal 122 and which outputs in response one or more command signals on terminals 124, 126. Detector 120 may be implemented a number of ways including as a phase detector, e.g., multiplier, or a burst continuation circuit, as explained in more detail below. The burst continuation circuit provides internally a substantially normal phase angle signal to be compared with the phase angle modifications of the input waveforms. The resulting e.g. command, signals on terminals 124, 126 may for example, be a particular bit or digital pattern signal “Command 1” when a weakened two line color stripe signal in accordance with the invention is read, meaning detected. When a greater than two line weakened color stripe signal is read, a similar or different bit pattern signal “Command 2” may be generated. In FIG. 4 for example, when a two line weakened color stripe input signal is sensed, the “Command 1” signal is output, which can then control a device to add or encode or re-encode on the well known “Type 2” Macrovision Corp. compliant signals for copy control. Such a Type 2 signal would include or encode or re-encode a same weakened or non effective or different effective color stripe signal and/or one or more of the following copy protection signals or signals that are a part of a copy protection or content control signal:

1) AGC pulses and/or Back Porch Pulses
2) Lowered portion of an active field or of a front or back porch region
3) Pseudo synchronization pulses and/or a narrowed synchronization pulse
4) N line color stripe signal

Similarly for a greater than two line weakened color stripe input signal that is detected, the “Command 2” signal output on terminal 120 may produce the well known Type 3 Rovi Corp. APS signal including the same or different color stripe signal as mentioned above and/or any of waveforms 1-4 listed above. An effective color stripe signal may include more cycles of incorrect phase angle than cycles of correct phase angle in a horizontal blanking interval, which may include an extended horizontal blanking interval.

Command 1 or 2 may direct a downstream device to mute, switch signal source, or shut down (e.g., upon sensing any of the “defeated” color stripe waveforms).

FIG. 5 shows a typical compliant device 130 such as a video recorder, analog to digital converter, or video display device having video input terminal 132. Such a device 130 includes a detector 120 as in FIG. 4, and when any waveform in accordance with the invention is sensed, device 130 responsive to the detection stops recording, stops outputting a program video output, scales the video signal, and/or ceases to display the program video. Device 130 may re-encode, upon sensing any of the weakened color stripe signals in any combination of basic copy protection signals and/or enhancement signals, a similar or different copy protection signal of like resolution or like television standard or different resolution or different television standard and output the resultant signal on terminal 134.

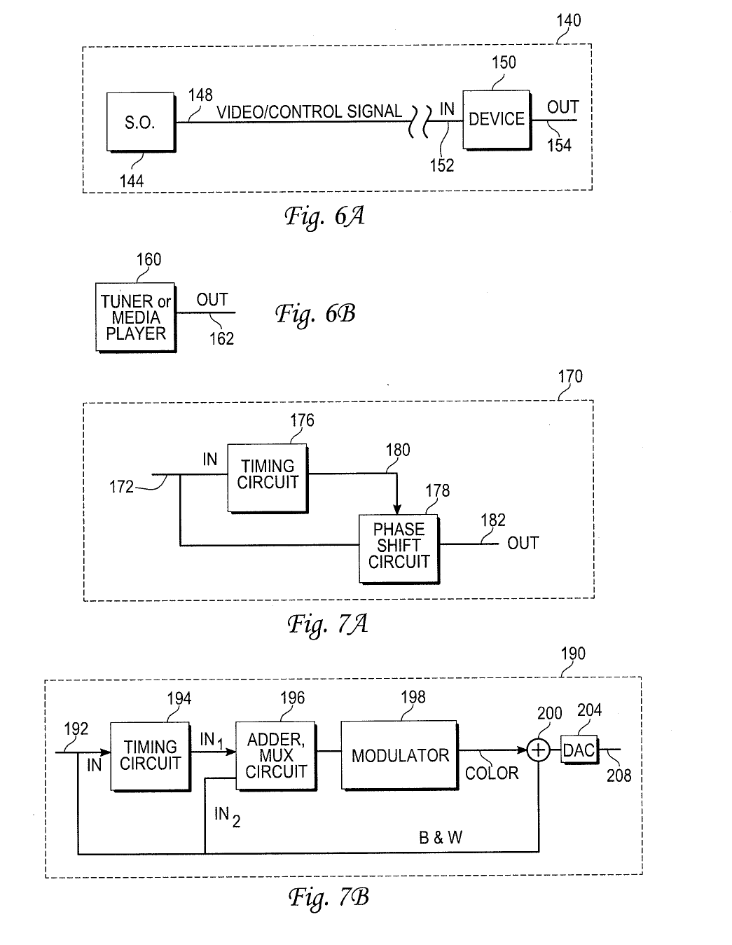

FIG. 6A shows an example of a cable or satellite television distribution system 140 including a system operator (S.O.) 144 that provides or transmits video and control (analog or digital) signals via communications channel 148 to a customer video device 150, e.g., a set top box, PVR, tuner, display, cell phone, etc. Channel 148 may be optical, wireless, wired, cable, satellite, Wi-Fi, WiMax, and/or the Internet. The signals on channel 148 may include program video and one or more control bits, bit pattern(s), or programming bits. Upon reception of these signals at terminal 152, video device 150 outputs the above described weakened color stripe waveforms when enabled by the control or programming bits or bit pattern(s) sent by system operator 144. Alternatively, device 150 may default to output one or more waveforms in accordance with the invention with or without the system operator transmission of the control or programming bits via channel 148 coupled to input terminal 152 of device 150. The output signal of device 150 at output terminal 154 is typically analog video including one or more weakened color stripe waveforms in accordance with the invention, which may be combined with any copy prevention signal such as pseudo synchronization pulses, AGC pulses, e.g., in a portion of the horizontal and/or vertical blanking interval, synchronization pulse modification, e.g., synchronization pulse reduction, synchronization pulse level shifting, synchronization pulse width narrowing/widening, synchronization pulse position/shifting), and/or level shifting a portion of the video signal. In FIG. 6A the signal on channel 148 is generally a digital signal used in a digital delivery network such as a digital television set top box without recording capability. It should be noted there are set top boxes today with recording capability, and thus FIG. 6A may apply to set top boxes with a recorder. FIG. 4 in contrast depicts a detector 120 which is generally used in a device that includes an analog input such as a recorder. This recorder would normally inhibit recording the program video upon detection of the analog weakened color stripe signal. Device 150 in FIG. 6A may include an analog input terminal (not shown), so then device 150 would include the apparatuses of FIGS. 4 and/or 5, a color stripe detector, and/or recording device. Generally if a compliant device has an analog input terminal, it would include a detection system such as in FIG. 4, and also a compliant recording system as in FIG. 5. So there are actually some digital devices, e.g., a version of device 150 that can be connected to a digital network, where such devices include a recorder, and also accept one or more analog inputs. FIG. 6A thus is an example of how the weakened color stripe signal can be used in a digital delivery network, such as described in Wonfor et al. U.S. Pat. No. 6,381,747.

FIG. 6B shows an example of a tuner or media player or PVR, tuner, receiver, cell phone, digital media center, set top box, etc. 160 which outputs analog video on line(s) or terminal 162 including one or more color stripe waveforms in accordance with the invention, which may be combined with any pseudo synchronization pulses, AGC pulses, e.g., in a portion of the horizontal and/or vertical blanking interval, synchronization pulse modification, e.g., synchronization pulse reduction, synchronization pulse level shifting, synchronization pulse width narrowing/widening, synchronization pulse position/shifting, and/or level shifting a portion of the video signal. FIG. 6B thus represents various devices that may be connected to a system operator as in FIG. 6A, or a video delivery network not having a system operator as in FIG. 6A. For instance, the video can be sent via a home computer network.

FIG. 7A shows in a block diagram an example of a generator apparatus 170 to generate weakened color stripe signals in accordance with the invention. The apparatuses of FIG. 7A or 7B or an equivalent circuit/system is present in device 150 or device 160 of FIGS. 6A, 6B. A conventional video signal is coupled to input terminal 172, which is coupled to a timing circuit 176. Timing circuit 176 provides a signal (that may be programmable by one or more control bits, not shown) for selected television horizontal lines and pixels for a modified color burst. The video signal at input terminal 172 is then provided with a color burst signal that is phase shifted by phase shift or phase generating circuit 178 according to the timing output from timing signal circuit 176 on line(s) 180 to provide at output terminal 182 one or more waveforms of weakened color stripe. Phase shift circuit or phase generating circuit 178 may provide or insert a color burst of modified phase and/or duration for one or more segments of the color burst envelope as explained above. The video signal input at terminal 172 may be analog or digital.

FIG. 7B shows in a block diagram another generator apparatus 190 to generate such weakened color stripe waveforms. The input video signal is coupled to input terminal(s) 192. The video signal is thereby coupled to a timing circuit 194 and the output of timing circuit 194 provides a signal coincident with selected lines and pixels of the video signal for color burst modification. The output of timing circuit 194 is coupled to one input (IN₁) of a switching, multiplexing (MUX), inserting, or adder circuit 196. A second input (IN₂) to adder circuit 196 is from the video input terminal 192. The output signal from adder circuit 196 then has a modified portion of the horizontal blanking interval and is coupled to a subcarrier modulator, e.g., multiplier, circuit 198 to provide a color burst of modified phase, amplitude, position, and/or duration as described above.

Typically the input signal to terminal(s) 192 is a digital component waveform having Y, Pr, Pb component video or the like. The Y component signal is denoted as the black and white video signal (B&W) which is summed by adder 200 to a modulated color signal via Pr and Pb multiplied by a carrier from modulator 198 including one or more color burst modifications to provide a composite digital television signal. A digital to analog converter (DAC) 204 then provides an analog video signal, e.g., composite video, Y/C video, or S-Video, at output terminal 208 that includes one or more color burst modifications in accordance with the invention. It is to be understood that an apparatus as in FIGS. 7A, 7B may be included in a video processor/encoder also performing other functions.

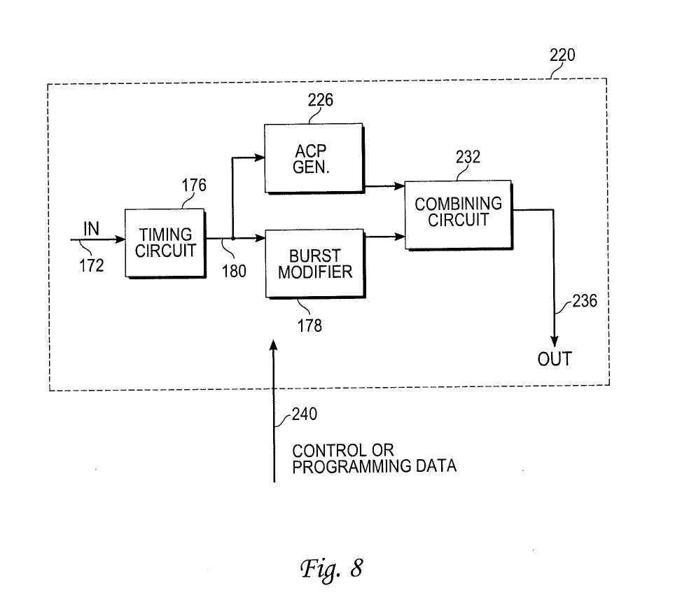

FIG. 8 shows in a block diagram a typical apparatus, e.g. an integrated circuit or portion thereof 220, which allows one or more of the present color burst modifications to be combined with one or more basic copy protection signal(s) and/or enhancement signal(s) and is based on the FIG. 7A apparatus. A video signal is coupled to input terminal 172. Timing circuit 176 outputs signals as in FIG. 7A indicating selected lines and pixels for the color burst modification signal, and outputs signals in selected lines and pixels for providing copy protection signals, which include:

1) Synchronization pulse modification(s) such as synchronization pulse reduction, synchronization pulse level shifting, synchronization pulse width, synchronization pulse amplitude, and/or synchronization pulse position.
2) One or more pseudo synchronization pulses in an overscan area.
3) One or more AGC pulses in an overscan area
4) Modulation (e.g., amplitude, frequency, position, and pulse-width) of AGC, synchronization, and/or pseudo synchronization pulse(s).
5) Level shifting a portion of the video signal.

The output signals of the ACP (copy protection) signal generator 226, and burst modifier, e.g., phase shift or phase generator, circuit 178 are coupled to a combining circuit 232, which outputs a digital and/or analog signal with one or more color burst modifications in accordance with the invention, and which at the output terminal 236 may include any of the copy protection signals mentioned above. Configuring, enabling, and/or disabling any of the signals mentioned copy protection and/or color burst modification may be via a control signal or bit pattern applied at terminal 240. Thus, the control signal at 240 includes one or more bits or a bit pattern, e.g., from a system operator, a memory device, storage device, media, etc.

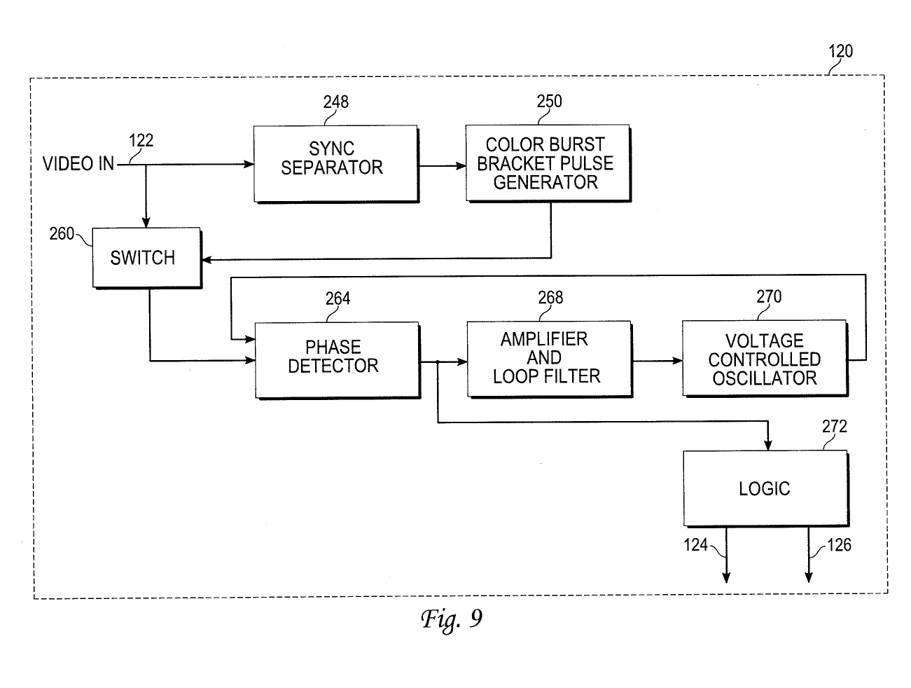

FIG. 9 shows in a block diagram detail of an exemplary weakened or defeated color stripe detector 130 of FIG. 5, and which is somewhat similar to that of Brill et al. U.S. Pat. No. 6,600,873 referred to above Like the other devices referred to herein, this may be embodied in its entirety or in part as an integrated circuit. Detector 120 has video input terminal(s) 122 coupled to synchronization separator 248 to separate out the synchronization pulses in the input video. The extracted synchronization pulses drive color burst bracket generator 250 which is, e.g., a mono stable multivibrator outputting a signal of at least 1 μsec duration. The output signal of generator 250 is coupled to the control element of switch 260. Switch 260 thereby couples the input video to phase detector 264 during the expected duration of the color burst. The output of phase detector 264 is coupled to amplifier and loop filter 268, in turn coupled to voltage controlled oscillator (VCO) 270. The output of VCO 270 is coupled to a second input terminal of phase detector 264 to provide a phase lock loop circuit. VCO 270 provides a continuous signal that is phase locked to the average phase of all incoming color burst signals, wherein the majority of color burst signals are of normal phase. Phase detector 264 outputs an indication of incorrect phase to logic 272 which determines, based on the incorrect phase indications, the presence/absence of various versions of the color stripe process and outputs suitable commands on terminals 124, 126 as in FIG. 5. Further, a monostable multivibrator circuit is a type of a timing circuit useful here, as is any type of equivalent circuit such as a digital counting circuit to generate a timing pulse.

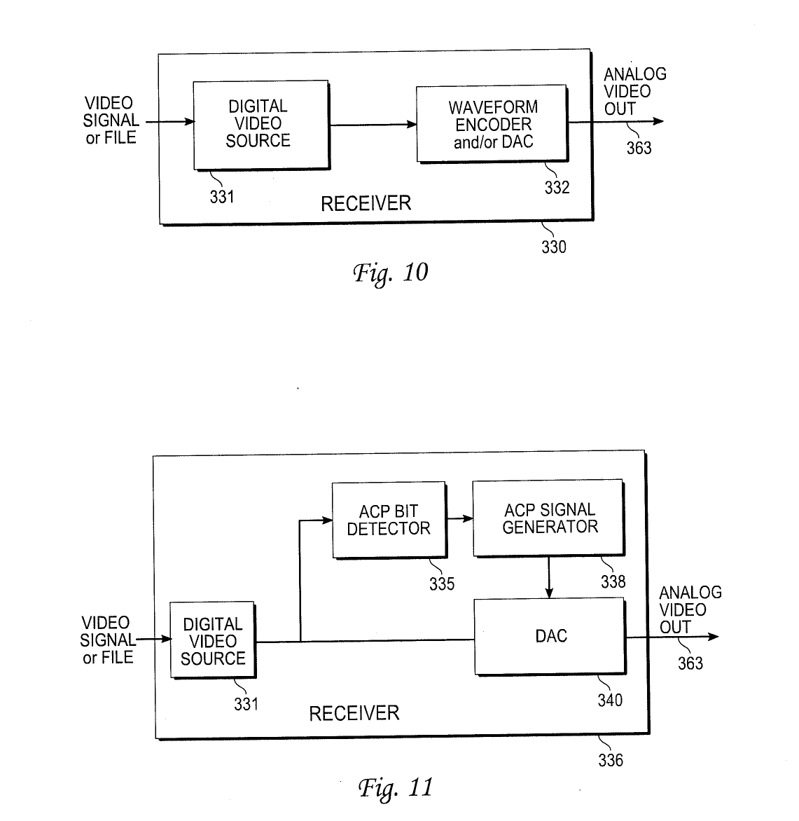

FIG. 10 illustrates in a block diagram an embodiment of a tuner or receiver 330. Such a receiver 330 may be a set top box (for receiving cable, Internet Protocol television, or satellite television), a television set, a mobile television device, a mobile phone, and/or the like and including a conventional digital video source 331. Video source 331 is e.g. a conventional port for receiving a video signal and/or a video file such as from the Web, a digital network, an RF (radio frequency) signal source (such as cable, Internet Protocol, or satellite television), and/or an optical signal which is conventionally converted to an electrical signal as described above. Video source 331 may receive video programming or programs from a digital delivery network, the Internet, a LAN, Wi-Fi, a wireless network, WiMax, and/or a system operator. The video source 331 may receive a digital video signal, radio frequency video signal, and/or an analog video signal. Although not shown, receiver 330 may include the capability of receiving analog television signals, with source 331 for example being an analog or analog/digital video source. Many receivers may include a combination analog and digital tuner for example to receive traditional AM/FM radio frequency signals along with digital television signals such as multilevel vestigial sideband and/or phase modulated signals.

Also included in tuner or receiver 330 and coupled to video source 331 is a waveform encoding circuit or encoder and/or Digital to Analog Converter (DAC) 332 which provides a video analog output signal including one or more of the waveforms such as the copy protection signals described above which are a weakened color stripe signal, or provide improved playability in a record or content controlled (and/or copy protected) video signal in accordance with the invention. Video source 331 thus may receive signals from a wireless transmission, digital network, a wired network or cable system, and may further be coupled to receive video from a (conventional) recorded medium played on a conventional magnetic drive, e.g., tape and/or disc, a conventional solid state memory device, e.g., flash drive, compact memory card, memory card, SD card, memory chip(s), and/or conventional optical disc playback device such as a CD, DVD or Blu Ray player, not shown.

The encoder and/or Digital to Analog Converter 332 is coupled to the video source 331 and outputs an analog video signal including one or more of the record or content control and/or copy protection waveforms described above, thereby to provide an analog copy protected video signal, content control signal, and/or weakened color stripe signal at video output port 363. This record or content controlled (and/or copy protected) video signal may be “on” by default, e.g., any of the present record or content control or copy protection signals can be provided in the output signal of the media player 330 upon power up, or at all times, or turned on by one or more control bits which is a command provided from within the video source 331 or by externally provided signal(s). The DAC is used in embodiments where the digital video source 331 receives an encoded signal or other signal already containing a record or content control or copy protection signal.

Such control bit(s) or a bit pattern may select one or more record or content control (and/or copy protection) waveforms or video signal modifications at video output port 363. For instance, in a 525 or 625 scan line television system, one or more weakened color stripe signals is added to a portion of the video signal, e.g., for the apparatuses of FIGS. 10, 11, 12, and 13, to provide a negligible color distortion effect on a VCR or television, while causing a downstream (receiving) compliant device such as a recorder to receive and detect the weakened color stripe signal and thereby for example cause the compliant device or recorder to inhibit recording, limit recording time, limit the number of recordings, provide a time window for recording, and/or provide enhanced or degraded video and/or audio quality. For example, a compliant device provides record and/or content control of a video program.

FIG. 11 illustrates a second embodiment of a tuner or receiver 336 that includes a record or content control (and/or copy protection) bit detector 335, here a copy protection (ACP) bit detector. Copy protection bit detector 335 reads or senses a digital bit stream in the digital video signal or file received at the video source 331. For example, upon sensing one or more such bit(s) in the output of video source 331, bit detector 335 transmits a command/or signal to a record or content control (and/or copy protection—ACP) signal generator 338 to provide one or more copy protection signals, or signal modifications as mentioned above, to a Digital to Analog Converter (DAC) 340. DAC 340 in response outputs an analog copy protected video signal or content control signal at video output port 363, which includes record or content control and/or copy protection signals and/or weakened color stripe signals, and/or provides improved playability of the record or content controlled and/or copy protected video signal. Note that DAC 340 is also coupled to the video source 331 to convert the received digital video signal to analog form.

FIG. 12 illustrates a third tuner or receiver 344, with more flexible programmability of the record or content controlled and/or copy protected video signal. Video source 331 here is coupled to provide the digital signal or file to control bit reader or sensing circuit 346, which typically outputs one or more signals to program various copy protection or content control parameters of the copy protected video or content controlled signal. Circuit 346 is coupled to control a programmable waveform generator 348 which thereby provides the flexibility for a user to program one or more record or content controlled and/or copy protected video signals and/or weakened color stripe signals. The digital output signal of waveform generator 348 is coupled to an encoder which generates or provides color subcarrier signals including a weakened color stripe signal and/or to DAC 340. The encoder is used in those embodiments where the weakened color strip signal may require provision of a modulated subcarrier in the digital domain. DAC 340 provides a weakened color stripe signal in the analog domain at video output port 363. For record or content controlled (and/or copy protected) signals generally the AGC or pseudo synchronization pulses or other luminance signal modifications from waveform generator 348 can be coupled directly to the DAC 340. DAC 340 is also coupled to the video source 331, e.g., a tuner or demodulator by itself or a tuner or demodulator with a playback mechanism or media reader. Note that some set top boxes with programmability of the ACP waveform via generator 348 include tuners for television and/or Wi-Fi reception along with a playback mechanism for reviewing video or picture files. The analog output video signal at port 363 thereby includes a copy protected waveform, content control signal, and/or a weakened color stripe signal with programmability, and/or provides improved playability, e.g., a weakened color stripe signal that is ineffective on a VCR thereby provides improved playability over an effective color stripe signal of the content controlled (or copy protected) video signal.

Such programmability, for example provided by the waveform generator 348, includes employing conventional Analog Protection System (APS) bits to implement an APS defined Type-n signal. For instance, a Macrovision Corp. Type 1 APS signal may include pseudo synchronization pulses in selected television lines. An APS command conventionally generates a Type 1 or Type n signal. So the Type 1 signal must be tied to a particular APS bit pattern. A Type 1 signal may include content control signal and/or copy protection signal such as synchronization pulse amplitude reduction in selected television lines, lowered horizontal blanking interval front porch level in selected television lines, and/or lower back porch level in selected television lines. A Type 2 content control or copy protection APS signal may include a Type 1 signal with a first type of color stripe modification (CS), e.g., partial, full or split burst weakened color stripe signal. Or an APS Type 3 signal may include a second type of color stripe modification (CS) signal which is a weakened color stripe signal along with a Type 1 signal. Note that a Type 2 signal may have an “M” television scan line weakened color stripe process. A Type 3 process may have an “N” television scan line weakened color stripe process or vice versa. For example M<=2, N>=3.

Such programmability, accomplished for example via the waveform generator 348, may include programming the television scan line assignment of the pseudo synchronization pulses, the number of pseudo synchronization pulses per scan line, the position of pseudo synchronization pulses, and/or the width of pseudo synchronization pulses. Programmability may include a negative or positive voltage level to be assigned selected television lines for front and/or back porch region(s) of video line horizontal blanking intervals. U.S. Pat. Nos. 5,583,936 and 7,050,698 relate to adding or inserting an amplitude lowering signal in the front and/or back porch area; both are incorporated by reference in their entireties.

Lowering and/or raising levels in one or more selected portion of the video signal outside a horizontal blanking interval may be part of the programming capability, e.g., of the waveform generator or a biasing circuit. For example, a portion of the video signal waveform such as the blanking level, front or back porch of the video signal's vertical blanking interval may be raised (or lowered) in terms of amplitude, meaning voltage, with respect to one or more television scan lines outside the vertical blanking interval or vice versa. For a color burst modification (e.g., the above described weakened color stripe process and/or television effective color stripe process), such programmability may include selecting television scan line assignment for the modified color burst and/or unmodified color burst, phase angle, zone(s) of correct or incorrect phase, and/or duration of one or more zones of the color burst. Such modifications of the color burst are disclosed in U.S. Pat. Nos. 6,516,132 and 7,039,294, both incorporated by reference in their entireties.

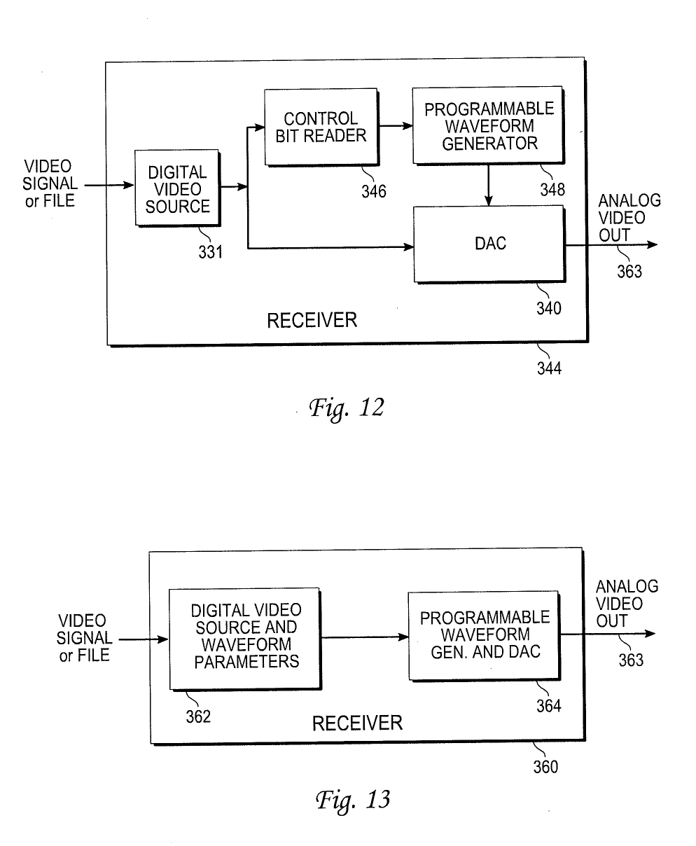

FIG. 13 illustrates a fourth embodiment of a tuner or receiver 360. Here a digital video source 362, similar to that in FIG. 12, is coupled to a combined programmable waveform generator and DAC 364, where the digital video signal output from video source 362 includes, in addition to the video program signal, added waveform parameter information which is bit or bits and which allows programming of the content control signal or copy protected waveform. The digital video source 362 thus may provide a signal from a television demodulator and/or tuner or from a solid state memory, optical disc, and/or magnetic disc or tape, which outputs the digital video signal containing programming information or actual waveform(s) for instance to provide flexible implementation of the content control signal or copy protected waveform, which can change from one recorded media version to another. For example, not only are the content control signals or copy protection signals or copy protected waveforms or weakened color stripe signal output from the programmable waveform generator and DAC 364, the copy protected waveform(s) and/or modified color burst signal which is the weakened and/or effective color stripe signal may be updated to a new waveform to further improve content and/or copy protection effectiveness on a downstream VCR or compliant device, or to further improve playability. U.S. patent application Ser. Nos. 10/968,487 and 11/228,757 describe examples of programmability of record or content control or copy protection signals, e.g., programmability of copy protection or content control signals for any of the embodiments of the invention, from the media or external sources, (e.g. for a media player or for a received transmission, updating its record or content control signal(s) and/or copy protection signal and/or modification to the video signal is provided via any combination of media, memory device, storage device, Internet, digital network, computer, etc; both these patent applications are incorporated by reference in their entirety.

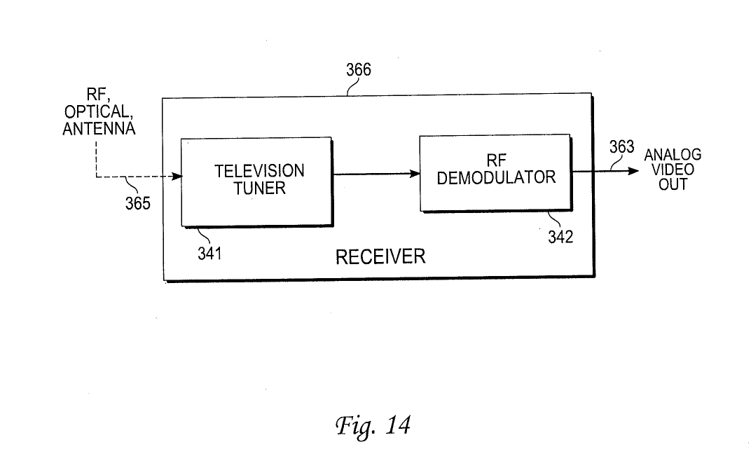

FIG. 14 illustrates another exemplary tuner or receiver 366. Here the video source of the receiver is a signal source 365 such as an antenna, RF source, and/or optical link that is coupled to an input of conventional television tuner 341. If the signal is optical it must first be conventionally converted to the electrical domain. The output of television tuner 341 is coupled to a conventional radio frequency (RF) demodulator 342. A typical demodulator 342 is a circuit for I and/or Q demodulation, phase demodulation, amplitude demodulation, frequency demodulation, and/or pulse code demodulation. Television tuner 341 may include a decompression system for processing signals which conform to standards such as MPEG-x, H.26x, advanced video coding (AVC), wavelet, DCT, DFT, motion JPEG, motion GIF, or the like. The output port 363 typically provides a digital video signal but may include an analog video output when a Digital to Analog Converter (DAC) is part of RF demodulator 342.

Although not shown in FIG. 14, an input port of a DAC may be coupled to the digital output port of demodulator 342 to provide an analog video signal which includes any of the present weakened color stripe signals. For an analog signal apparatus or application device, such as an analog mobile television device, the FIG. 14 tuner or receiver may include an analog RF tuner 341 which includes RF demodulator 342 to detect or demodulate an analog television transmission, e.g., vestigial sideband which is an amplitude modulated signal transmission, from signal source 365. The output signal of demodulator 342 may be coupled to a circuit or apparatus which provides a video signal including one or more variants of the present weakened color stripe signal. The one or more variants of the weakened color stripe signal may be further combined with any of the basic copy protection signals and/or enhancement signals or processes described above. The output signal of demodulator 342 may include a control signal to enable or disable the weakened color stripe signal or copy protection signal, or include a control signal to program the weakened color stripe signal or copy protection signal. The control signal, e.g., for an analog or a digital television system may be embedded or added to the video signal via one or more of the following: a separate data channel, audio channel, video and/or audio watermarking signal, data signal added to the video signal's overscan area such as a portion of the vertical or horizontal blanking interval or portion of an active television line, a flag signal or broadcast flag, or a pedestal voltage in a portion of the video signal to convey a command for enabling or disabling or programming the weakened color stripe signal, content control signal, and/or copy protection signal. Another embodiment includes a default enabling of the weakened color stripe signal. The control signal or control bit pattern may be derived from a metadata and/or program guide signal.

In the video receiver apparatus examples of FIGS. 10-14, changes to the content control or copy protection waveform may be implemented responsive to commands provided from a source internal or external to the apparatus, such as a link to a transmission site or a “smart card” or similar storage or memory device thereby providing the programmability referred to above. U.S. Pat. Nos. 6,381,747 and 7,395,545, which describe a receiving system pertaining to providing signal modifications for content control and/or copy protection are hereby incorporated by reference in their entireties.

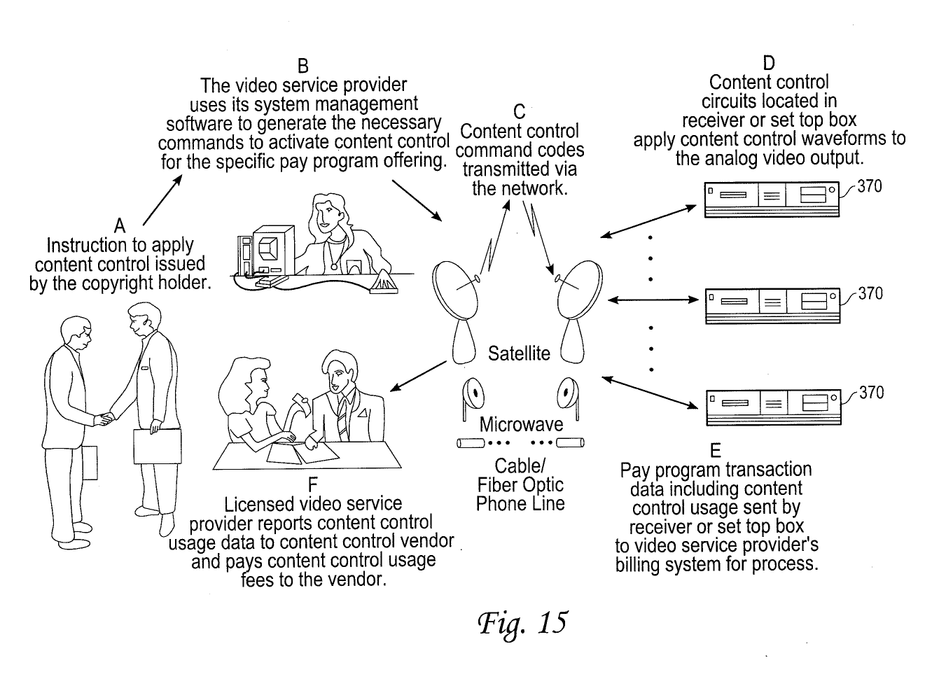

FIG. 15 illustrates diagrammatically a control and tracking method and system for enabling and controlling application of record or content control (and/or copy protection) of video signals and the like via digital video networks. Part A represents the issuance of control instructions to video service providers by asset rights holders who hold the asset (program) copyrights, for the application by the providers of record or content control and/or copy protection to the programs which are content controlled or protected by pay program, such as pay per view (PPV) or pay to tape (PTT) or pay to record (PTR), requirements.

Part B depicts a control and billing center of those video service providers who supply record or content control signal and/or copy protection signal control software for the respective content controlled (and/or protected) programs being broadcast, to generate the commands required to activate, control and reconfigure the record or content control and/or copy protection process for each specific pay program offering. Although a single provider is depicted, it is understood that part B represents any one of a plurality of video service providers each with their respective proprietary control and tracking or billing software, in accordance with the present invention.

Part C represents the procedure of transmitting the particular record or content control (and/or copy protection) command codes of the respective providers, for the pay program offerings, via the typical broadcasting or other transmission networks. Such transmissions may be made by satellite, microwave link, phone line or cable transmission systems, as depicted.

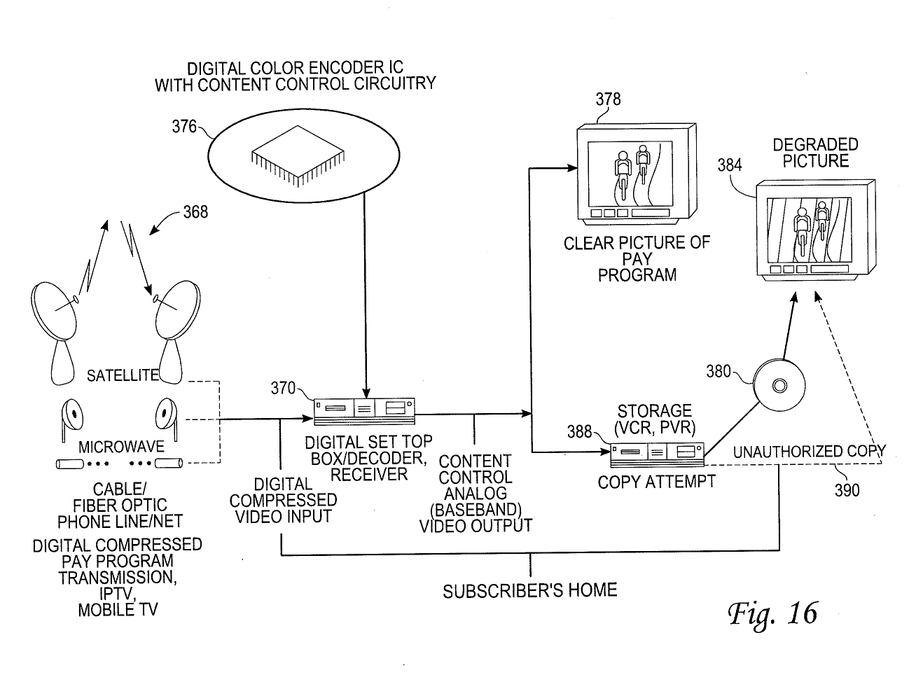

Part D represents a subscriber's home, or other receiving facility, and includes a set-top box 370 for each subscriber. Each set-top box 370 contains record or content control (and/or copy protection) circuit including a digital color encoder integrated circuit, which is adapted to apply selected record or content control (and/or copy protection) waveforms as described above to the analog or digital video signal which is supplied there from to a television set or monitor or other video display device. Receiver or set top box 370 is also shown in FIG. 16.

Part E represents the procedure whereby data identifying each pay program transaction, including content control or copy protection usage, is sent by the set top box 370 back through the transmission networks of station C, generally to the respective video service provider's control and billing or tracking center. The center includes billing procedures which are a subset of the system control software and which process the return transaction data to provide for billing the subscriber for the pay program transaction usage.

Part F represents the procedure whereby each video service provider reports the content control or copy protection rights usage to the asset (program) rights holder or other vendor, whereby the provider pays the record or content control and/or copy protection) fees to the rights holder, e.g., the licensor.

FIG. 16 illustrates in further detail the subscriber's facility, part D of FIG. 15, receiving the digital, and usually compressed, such as pay-per-view transmissions 368 from the broadcasting networks depicted as part C of FIG. 15 or from Internet Protocol television, mobile television, handheld television, Wi-Fi, WiMax, a computer network, etc. The compressed digital video signal, or the like, is supplied to the respective set top box 370 which is one of many such set top boxes, wherein each set top box 370 includes as described above conventional circuit for converting and decoding the digital compressed video signal to an analog or baseband RF video signal. The set top box 370 also includes a digital color encoder IC 376 as described above which contains content control or copy protection circuit for applying the selected record or content control and/or copy protection waveforms or signals to the analog or digital video signal, namely, the programs which are being controlled in content and/or being protected. In this example, the content control or copy protected analog baseband video is supplied by the set top box to a conventional television set 378 where the pay protected program is clearly displayed for viewing if the subscriber is authorized to view the program. If the subscriber is not authorized for a particular pay protected program, the corresponding picture is modified so as to be unviewable. Examples of an unviewable picture include a scrambled picture, a degraded picture, a substituted video frame, etc.

In the event a subscriber records the pay protected program via a conventional digital or personal video recorder (storage device) 388 to obtain a recorded copy 380 on the disk drive of the recorder 388 without authorization, the unauthorized copy 380 will be degraded or altered to the degree that it is unwatchable, as depicted by television set picture 384. In another example, video recorder 388 is a compliant device as described above, e.g., a video recorder with an installed content control system, and upon reading the video signal modifications received from set top box 370, the recorder 388 may shut down recording resulting in “no picture” at television set 384, limit recording (storage), and/or provide an altered resolution or quality of recording. However, if the subscriber subscribes to a pay to tape or pay to record transaction and to the required higher pay to tape or pay to record transaction fee, then the copy is authorized and the resulting recorded copy 380 would be readily watchable.

In the example of FIG. 16, the content control or copy protection signals from set top box 370, including a weakened color stripe signal, are coupled to a recorder (storage device) such as a digital personal video recorder (PVR) 388. PVR 388 may be or include a computing device such as a computer with video recording capability or an analog to digital converter device coupled to a computer or computing device for video recording. Within the PVR or analog to digital conversion device, a reader or sensing circuit will interpret one or more variations of the weakened color stripe signal to provide a content control command to the recorder or analog to digital converter device. Examples of a content control command may include any combination of the following: produce a poor/degraded signal or copy, cause a limitation in recording (e.g., limited time window of when a program be recorded, or limited number or copies of the video program), shut down recording, replace at least part of the program video signal with another signal, or produce an altered resolution television signal. The video output of set top box 370 may include other content control or copy protection signals such as AGC signals, pseudo synchronization pulses, lowered portion of a video signal, altered pulse width of synchronization pulses (e.g., narrowed selected H or V synchronization pulses), and/or added pulses in a portion of the active line whose negative portion includes a range from about blanking level to below blanking level, e.g., but not to synchronization pulse tip level.

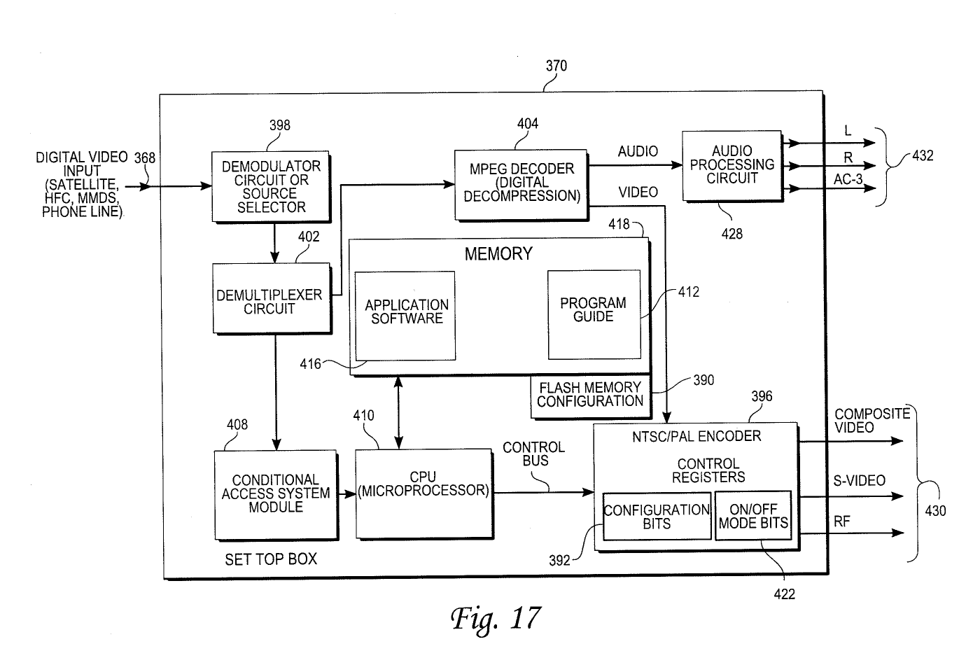

FIG. 17 illustrates further detail of set top box 370 of FIGS. 15 and 16. For example, upon power up of set top box 370, the configuration bits stored in e.g. flash memory 390 are read and written into the appropriate content control or copy protection which is content protection or copy protection configuration bits (e.g., control registers) 392 in the NTSC/PAL video encoder 396. A compressed digital video signal 368, e.g., complying with MPEG-x, Wavelets, H.26x, JPEG 2000, AVC-advanced video coding, or DCT and also including the content control or copy protection control commands described herein, is supplied by a delivery network as described above which is e.g. the Internet, satellite, HFC, MMDS, or phone line, to a demodulator circuit 398. The demodulated or otherwise selected video/audio and control signals are supplied to a demultiplexer circuit 402 where the video and audio signals are separated into respective channels and supplied to an MPEG-2 or MPEG-x decoder and digital decompression circuit 404. The content control or copy protection control commands are supplied from the demultiplexer circuit 402 to a conditional access system module 408. The commands are then supplied to a microprocessor or Central Processing Unit (CPU) 410. The CPU 410 processes information located in memory 418 that is associated with a programming guide 412 and runs the content control or copy protection application software 416 residing in memory 418 to deliver the activation command to the NTSC/PAL video encoder 396. The programming guide 412 may also have data which is used to determine if a signal related to record or content control and/or copy protection should be activated. There are other known methods that may be employed to activate content control or copy protection.

In response to the control commands, the CPU 410 supplies control signals to the NTSC/PAL video encoder 396. Video encoder 396 includes content control or copy protection control bit storage (e.g., registers) 422, 392 for respectively receiving and storing the on/off mode bits and/or configuration control bits. Configuration bits 392 determine the form of the record or content control, e.g., location of lines with weakened color stripe signal and/or the type of weakened color stripe signal, and/or copy protection, e.g., where the pseudo synchronization and AGC pulses will be located or positions of the color stripe lines. The on/off mode bits 422 determine which components of the record or content control and/or copy protection process will be activated, see Table 1 below. The video encoder 396 also receives decompressed video from the MPEG decoder and digital decompression circuit 404. Video encoder 396 outputs a radio frequency signal, a composite video signal and/or an S-video signal via video output leads 430. The decompressed audio signal is supplied from MPEG decoder 404 to a conventional audio processing circuit 428 which, in turn, outputs left (L) and right (R) channel stereo signals and/or an AC-3 audio signal on audio output leads 432.

The following Table 1 from U.S. Pat. No. 6,381,747 shows an example of the on/off mode bits 422. Mode bits or a bit pattern or control bit(s) or N0[x] which are bits or bytes may be for example, derived or provided from at least a portion of a metadata or programming guide signal.

TABLE 1
Mode Control Bit Listing
Routine On/Off and Mode Selection

| NO | On/off and mode control; 8 bits | | |
|---|---|---|---|
| NO[7] | Reserved | | CPC0[3] |
| NO[6] | Pay-to-tape allowed/prohibited | (Allowed = 1, | CPC0[2] |
| | | Default = 0) | |
| NO[5] | VBI pulses On/Off (VBIP) | (ON = 1) | CPC0[1] |
| NO[4] | End of Field Back Porch Pulses | (ON = 1) | CPC0[0] |
| | on/off (EOFP) | | |
| NO[3] | Colorstripe process On/Off (CSP) | (ON = 1) | CPC1[3] |
| NO[2] | AGC pulse normal (amplitude | (Cycling = | CPC1[2] |
| | cycling)/static mode select | Default = 1) | |
| | (AGCY) | | |
| NO[1] | H-sync amplitude reduction | (ON = 1) | CPC1[1] |
| | On/Off (HAMP) | | |
| NO[0] | V-sync amplitude reduction | (ON = 1) | CPC1[0] |
| | On/Off (VAMP) | | |

It is preferred that the content control or record control waveform/signal (and/or anticopy) process on/off control is achieved by setting all the individual parameter on/off and mode control bits rather than a master on/off control. This requires that the N0 (N-zero) bits in the control bit listing be set as required. Depending on the individual system, this will require the control of 1 to 8 bits.

The delivery of the mode bits, e.g., one byte of data from on/off mode bits 422 (see FIG. 17) to the set top box 370 to activate or deactivate the content control or copy protection process may be accomplished in several ways. When selecting a mechanism to control the record or content control (and/or copy protection) technology, a service provider selects one of the following or may develop other methods. One method is for the mode bits to be delivered via the conditional access system module 408 via an entitlement control message (ECM). Another method is to include the mode bits 422 in a private data field in the MPEG transport data stream. For example, the MPEG data stream may include an MPEG-2 or MPEG-4 video compression format, which is typically delivered as a digital video signal. A digital video signal that is coupled to input 368 of FIG. 17 may include a digital television, DVB, ATSC, cable, wireless, optical, wired, and/or high definition television signal. Alternatively, a digital video signal may be provided by a delivery network such as via Wi-Fi, WiMax, Internet, or the like. A digital video signal coupled to input 368 may include video programs or movies or other video assets, which are typically encoded in a compressed format. In some instances, a digital delivery network may include uncompressed formats. For example, in the 60 GHz (radio frequency) band, digital video (e.g., via HDMI) is transmitted and/or received without compression. For a non-compressed video signal example, digital decompression decoder 404 would not be required and decoder 404 may be bypassed. A conditional access system module 408 of FIG. 17 may include information from metadata or a programming guide, which provides a mode byte such as mode bits 422.

Another method delivers the mode bits 422 in a user defined section of the programming guide, which however is not identified in released documentation as controlling content control or record control and/or copy protection. This method also requires additional security to keep the memory location of the mode bits 422 from being accessed for unauthorized changes and the setting of a return flag that indicates the actual status of the mode byte when transmitted to the video encoder 396. Another method may be a combination of the conditional access, ECM, programming guide, and/or metadata. The transport of the mode byte in the programming guide or metadata could be combined with one or more bits within the ECM, programming guide or metadata. For example, to activate the content control or record control and/or copy protection technology is a logical, e.g., Boolean AND/OR operation between the ECM bits and/or the programming guide bits. If either is set, the record or content control (and/or copy protection) technology, both (or either) ECM and/or programming guide, or metadata would indicate that deactivation is necessary.

In one embodiment, the content control or record control or copy protection control software (CPCS) resident in application software 416 in the set top box 370 is capable of applying and reporting content control or record control and/or copy protection usage according to the following conditions. The CPCS alternatively may be software module or set of software modules that reside with the service provider or system operator, which provides an interface to manage one or more attributes of a (pay program) content control or copy protection signal. The overall system allows the subscriber's content control or record control and/or copy protection to be turned off at the set top box 370 as permitted by the pay program rights holder or system operator as follows. In one embodiment, set top box 370 of FIG. 17 may include a communications link coupled to the system operator. This link may include an Internet connection. For example, a separate communication link via Ethernet, WiFi, satellite, cable, phone lines, fiber, etc. may be coupled from a set top box such as apparatus 370, or the terminal 368 may be bi-directional that allows receiving and/or sending information or signals via apparatus 370.

Two exemplary pay program modes are: A) Pay program rights holder permits viewing only. The pay to record/store to disc/storage to memory/tape or store is prohibited, hence off. An example of “pay to store” would include paying to store one or more video program files in a device such as receiver, player, set top box, etc. Storing may include writing the file onto a magnetic, optical, or electrical medium, which includes disk or solid state memory. In one embodiment all set top boxes output a content control or a record control copy protected waveform only. For example, the copy protection waveform unconditionally appears on the set top box analog video output signal or terminal. This is reported to the billing system as a “Pay Per View” copy protected transaction.

B) Pay program rights holder permits viewing and recording. The pay to record or tape or store mode (or control) bit is set for pay to record/tape/store, which is on. Under this option, when the subscriber selected the pay to record/tape option, the content control or copy protection process is turned “off” in the set top box to allow the pay program to be recorded via PVR, tape, memory, disc, or the like for a higher transaction fee than for “viewing only”. For example, the content control or record control and/or copy protection waveform will not be present on the set top box analog video output signal. This is reported to the billing system as a “pay to store” or “pay to record/tape” content control or record control (and/or copy protected) transaction.

Table 2 below, also from U.S. Pat. No. 6,381,747, incorporated herein by reference in its entirety, shows an example of pay to record, store, or tape control options for pay video programs generically referred to in this table as “Pay-Per-View” or “PPV” programs. It should be noted that “Pay To Tape” may be the equivalent of “Pay To Record” or “Pay-To-Store”. Table 2 provides a summary of the control options and includes additional information. In Table 2 copy protection may be replaced by content control or record control. Alternatively, the copy protection may include a content control or record control waveform, e.g., such as any embodiment disclosed here pertaining to a weakened color stripe signal, or a weakened color stripe signal and any combination of added pulses or modified voltage levels for a video signal. Any of these signals pertaining to content control or record control (that can be combined with added pulses or modifications in a voltage level of a video signal) may be programmed or enabled or disabled by any portion or bit pattern of a metadata or programming guide signal as described above.

TABLE 2
Pay Per View and Pay To Tape Control Options
for Pay Programs

| | Consumer | |
|---|---|---|
| | Request | |
| | (Pay Per View | |
| Program Descriptor of | or | |
| PPV Program | Pay To Tape) | Result |
| Copy protection NOT | N/A | ACP off |
| required | | |
| Copy protection | Pay Per View | ACP will be ON. |
| REQUIRED | | Pay-Per-View transaction |
| Taping NOT permitted | | cost incurred by consumer. |
| Copy protection | Pay To Tape | Requested option not |
| REQUIRED | | available. |
| Taping NOT permitted | | ACP will be ON. |
| | | Pay-Per-View transaction |
| | | cost incurred by consumer. |
| Copy protection | Pay Per View | ACP will be turned ON by |
| REQUIRED | | STB control system. |
| Taping permitted (at higher | | Pay-Per-View transaction |
| transaction cost) | | cost incurred by consumer. |
| Copy protection | Pay To Tape | ACP will be turned OFF |
| REQUIRED | | by STB control system. |
| Taping permitted (at higher | | Pay-To-Tape transaction |
| transaction cost) | | cost incurred by consumer. |

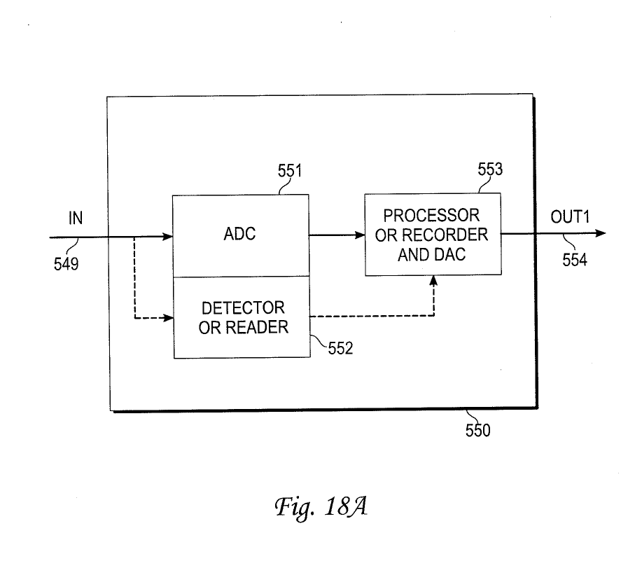

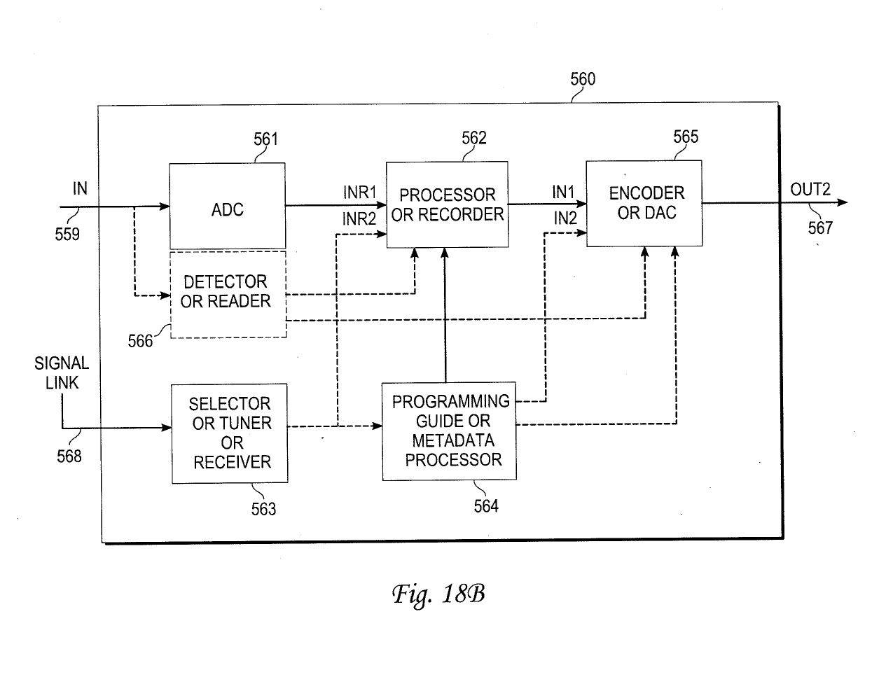

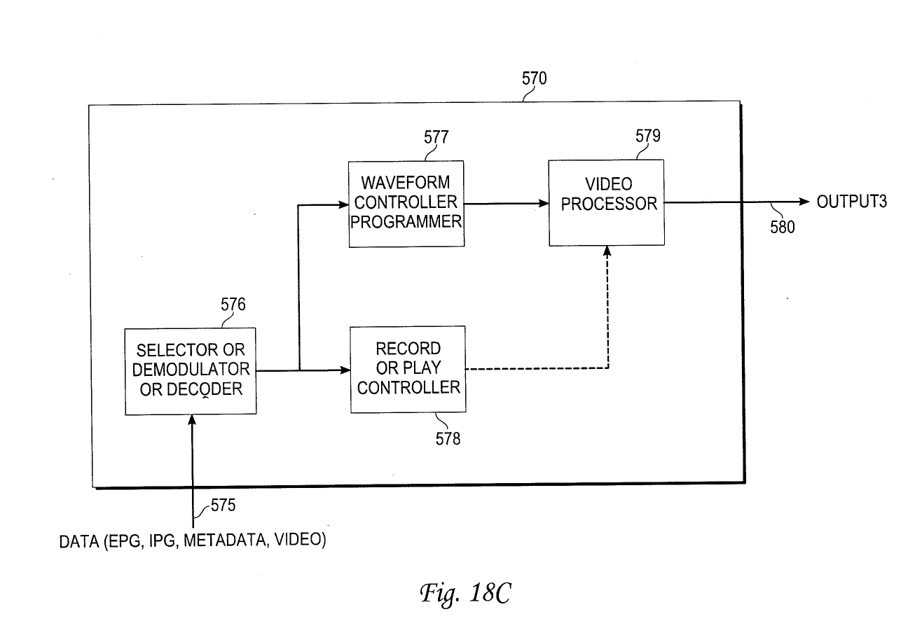

FIG. 18A illustrates in a block diagram a system, integrated circuit, system on a chip (SOC), and/or chip set 550, which includes a baseband video input port 549 coupled to an Analog to Digital Converter (ADC) 551, and a reading or detector circuit 552 for optionally sensing one or more protection signals. Thus, the sensing of the one or more protection signals may be done in the analog and/or digital domain. For example, an analog signal input at port 549, with one or more protection signals, may be coupled to the detector or reader 552, or may be coupled to the detector or reader 552 via a digital output of analog to digital converter 551. Detector or reader 552 senses the one or more copy protection or content control signal and sends one or more commands to a processor or recorder 553. For example, if a certain protection or content control signal is sensed, e.g., a pseudo synchronization, AGC pulse and/or color burst modification e.g., phase modulated or phase shift keying color burst signal, a command to shut down or limit recording/viewing may be sent to processor or recorder 553. In another example, if a protection signal is sensed, a command may be sent to processor or recorder 553 (e.g., a recording or processing circuit) so as to output for example program video OUT1 at output port 554 with the same type of content protection signal, another type of (content) protection signal, a weakened copy protection signal e.g., fewer pseudo synchronization and/or AGC pulses, and/or a weakened color stripe signal (WC), or effectively no copy protection signal.

Examples of input signals and output signals for system 550 may include input including a video signal with no rights protection (RP) signal, with an output video signal with a new content or type of rights protection (RP) signal that is resistant to black boxes (circumvention devices) and/or a new content or type of rights protection or phase modulated color burst protection signal with improved playability. A type of rights protection (RP) signal includes negative going pulses or pseudo sync pulses (e.g., one or more (negative) pulses per video scan line) in one or more scan lines within two scan lines (e.g. less than 2 scan lines) of the last scan line having post equalizing pulses for the vertical sync signal. In a standard pseudo sync process, the pseudo sync pulses occur at 2 scan lines or more after the post equalizing pulses. Thus, there are normally two scan lines that are normally blanked or that normally have no negative going pulses after the last post equalizing pulse. Certain circumvention devices sense the absence of negative going pulses for the one or two scan lines after the post equalizing pulses to identify the start of the pseudo sync pulses in the vertical blanking interval. Once the start point is identified by these circumvention devices, the standard pseudo sync pulses are deleted by signal modification circuits in the circumvention devices. For example, in a 525 scan line system (NTSC TV) the last post equalizing pulse scan lines are at scan lines 9 and 271. In a 625 scan line system (PAL TV) the last post equalizing scan lines are at scan lines 5 and 317. A standard 625 pseudo sync pulse signal may start with pseudo sync pulses at scan lines 8 and 320, which would be deleted by certain black boxes. It was found experimentally, by providing or including one or more pseudo sync pulses in scan lines 6, 7, 318, and/or 319 for a 625 scan line format (for a first type of rights protection signal), these certain circumvention devices did not remove sufficiently the pseudo sync pulses and/or the associated AGC pulses. Similarly in a 525 scan line format, providing/including one or more pseudo sync pulses in scan lines 10, 11, 272, and/or 273 (for a second type of rights protection signal) caused certain circumvention devices to fail in removing sufficient pseudo sync pulses and/or the associated AGC pulses. In at least one 525 scan line format circumvention device, providing pseudo sync pulse(s) or negative going pulse(s) immediately after the last scan line of post equalization pulses or end or vertical sync signal causes this particular 525 scan line format circumvention device to fail.

For example, to fail in a circumvention device in general means the circumvention device passes to its output port content control or copy protection pulse(s) or signal(s) and/or removes at least a portion of the active field, or color burst signal. A portion of the active field may include one or more portions of one or more scan lines outside the vertical blanking interval. The input may include a video signal with a standard rights protection signal that is not resistant to a black box, with an output video signal with a new rights protection signal that is resistant to black boxes and/or a new protection signal with improved playability. The input may include a video signal with a content or type of rights protection signal that is resistant to a black box, e.g., a black box or circumvention device that fails to sufficiently remove pseudo sync pulses and/or associated AGC pulses for circumventing content control or copy protection, with an output video signal with a rights protection signal not resistant to black boxes, and/or a new rights protection signal with improved playability. One or more type of rights protection signal is described in U.S. patent application Ser. No. 12/711,834, Method and Apparatus for Receiving Metadata, EPG, or IPG Signals in an Integrated Circuit for Control Purposes to a Recorder, incorporated herein by reference in its entirety.

Other combinations of input or output signals are possible for system 550. For example, the input signal may be a copy protected video signal with improved playability while the output provides a (content) protected video signal without improved playability where the improved playability signal includes any of the (content) protection signals with improved playability, or vice versa. For example, the input signal may include a weakened color stripe content control signal with improved playability, while the output signal of system 550 includes a color stripe signal with less improved playability or vice versa.

FIG. 18B illustrates a system, integrated circuit, system on chip, and/or integrated circuit set 560, in an embodiment of the invention, which includes optionally a source selector or tuner or receiver device 563 and optionally, a system to read signals from at least a portion of metadata or a programming guide for controlling a processor or recorder 562, and/or for programming/enabling/disabling a protection signal, e.g., a content or rights protection or phase modulated/phase shift keyed color burst signal such as a weakened color stripe signal, which is the above described color burst modification protection signal that provides resistance to a black box. A baseband video signal is coupled via an input port 559 to an input of analog to digital converter (ADC) 561, which optionally may include a detector or reader 566 of content control signal(s) in the baseband video input signal. By sensing signals such as pseudo synchronization, AGC, or data e.g., Copy Generation Management System (CGMS) pulses, or color burst modification(s), the detector or reader 566 may provide a command signal to a recorder or processor or recorder 562 to perform for example one or more of the following: allow recording/processing, prohibit recording/processing, provide an altered resolution or altered quality recording, provide copying or recording during a specific time or duration, or provide or allow a limited number of recordings. The detector or reader 566 may provide a signal to an encoder or digital to analog converter (DAC) 565 to synthesize one or more content or Type RP or phase modulated signal or color burst modification protection signals in any combination as dependent on the input signal. This may include a baseband input signal or a signal supplied via a processor 564 such as a metadata or programming guide signal. Alternatively, a default copy or content protection signal designated OUT2, such as a content or Type RP or phase modulated burst signal or weakened color stripe protection signal that is resistant to a black box, or an improved playability protection signal, may be synthesized on output port 567.

A signal provided on an input port 568 from a radio frequency source, a wireless source, Internet or digital delivery network, phone line, cable, fiber, optical, or satellite, is coupled to a source selector or tuner or receiver 563. Source selector tuner or receiver 563 may include a player, which plays back digital signals. An output port of tuner or receiver 563 optionally may be coupled to an input of the recorder or processor 562, or to the programming guide or metadata signal processor 564. An output signal of processor 564 may then contain information from programming guide or metadata signal(s) to control processing or recording for example, for recorder or processor 562 or to program/enable/disable content or Type RP or weakened color stripe protection signal(s) provided from the encoder/DAC 565. The programming guide or metadata may be transmitted or added or inserted in a baseband video signal or may be provided via a digital delivery system e.g., from a system operator, or as a digital data signal. For example, at least a portion of a signal including programming guide or metadata, may be used to control a video processing device or recording device, or may be used for programming/enabling/disabling one or more content control signals or content or Type RP or weakened color stripe protection signals, and/or for providing a (content) protection signal that provides resistance to a black box or provides improved playability.

FIG. 18C illustrates another integrated circuit (IC), system on a chip, chip set, and/or system 570. A data signal including video, programming guide data or metadata is coupled via an input port 575 to a source selector or demodulator or decoder 576. A bit pattern from at least a portion of the data signal from source selector or demodulator or decoder 576 is coupled to a waveform controller or programmer 577 to enable/disable/program any number of e.g. content or rights protection or weakened color stripe protection signals, and/or enhancement signals, which may include a protection signal to provide resistance to a black box, and/or to provide improved signal playability.

Programming guide data may be used as a command to pass or block a video program signal, and/or to alter video quality of the program video signal via a video processor 579. A signal designated OUT3 on output port 580 then includes for example a video signal with a content or type of rights protection or weakened color stripe signal, e.g., triggered or flagged by a bit pattern from a metadata or programming guide signal via for example a digital delivery network that provides resistance to a black box, or that provides improved playability.

Thereby one or more embodiments of the invention includes a content or rights protection or weakened color stripe protection signal supplied by an integrated circuit that improves video picture geometric distortion for better playability, a content or rights protection or weakened color stripe protection signal that reduces or defeats the function of a circumvention device, and/or a content or rights protection or weakened color stripe protection signal from an integrated circuit that triggers or causes a circumvention device to enhance protection effect(s). Such content or rights protection or weakened color stripe protection signals may be utilized in an integrated circuit including a digital to analog converter coupled to a source of digitally recorded material or digital video for providing a baseband video signal from a digital signal, a signal sensing or reader circuit for detecting or reading protection bit, a bit pattern or content control bit(s), and a signal generator for generating a content or rights protection or weakened color stripe protection signal at the output of the digital to analog converter in response to the protection bit, bit pattern, or content control bit(s).

Embodiments of the invention include any of the following. The protection signal is supplied via an output of the integrated circuit to an input of the circumvention device, where the output of the circumvention device passes at least part of the protection signal sufficiently for a rights protection or content control effect, and/or where the output of the circumvention device provides a signal to further distort or blank a portion of an active television field. The protected video signal from the integrated circuit is coupled to an input of the circumvention device, where the output of the circumvention device supplies a signal that is substantially effective in terms of rights protection or content control for a video recorder or for a content control system. A circuit for inserting or adding in at least one television line one or more pseudo synchronization pulses or one or more pseudo synchronization pulse or AGC pulse pair signals immediately after or less than two or two and a half lines after a vertical synchronization signal or post equalizing pulse, e.g., in an odd field, even field, or both fields, to for example provide resistance to a circumvention device.

Another embodiment includes method of providing a different number of pseudo synchronization pulses from one video scan line to another video scan line and/or different pseudo synchronization pulse widths from one video scan line to another, generating at least two scan lines consecutively with substantially the same number of pseudo synchronization pulses and/or substantially the same pseudo synchronization pulse width, e.g., for improved playability.

In another embodiment a content or rights protection or weakened color stripe protected video signal is supplied to a television set or other video display via an output of the receiving device, wherein improved playability is achieved e.g., via reduced “hooking” on a top portion of the television picture, e.g., by shifting the pseudo synchronization line locations closer to the vertical synchronization signal, or reducing pseudo synchronization pulse(s) near the beginning of the active field, or if the number of pseudo synchronization pulses alternates from scan line to scan line, provide two or more consecutive scan lines with the same or substantially the same number of pseudo synchronization pulses.

Another embodiment includes a method of starting or providing pseudo synchronization pulses immediately after or less than 2 or 2½ lines after a vertical synchronization signal or post equalizing pulse to provide the content or rights protection signal at an output of the integrated circuit, and may include one or more of the following: a color burst modification of whole or segmented portions of one or more color burst envelopes which includes one or more cycle of incorrect color burst, a weakened color stripe signal, level shifting of a portion of the video signal including lowering or raising one or more portions of the video signal, modifying synchronization location, amplitude, and/or pulse width in selected video lines, providing back porch pulses of different video levels from one video line to another, providing pseudo synchronization and/or AGC pulses of different pulse widths from one video line to another, providing pseudo synchronization and/or AGC pulses of different numbers from one video line to another.

The rights protection signal is supplied via an output of the integrated circuit receiver to an input of the circumvention device, wherein the output signal of the circumvention device passes at least part of the rights protection signal sufficiently for a rights protection or content control effect, and/or wherein the output of the circumvention device provides a signal to further distort or blank a portion of an active television field.

Combining pseudo synchronization and/or pseudo synchronization and automatic gain control (AGC) pulses immediately after a vertical synchronization signal or less than two or two and a half video lines after a vertical synchronization signal or post equalizing pulse, with the color burst modification, e.g. color stripe, partial color stripe, weakened color stripe, which in combination is generated at an output of the integrated circuit, where the color burst modification includes cycles of incorrect phase or frequency in selected video lines, wherein the baseband, composite, and/or component output of the integrated circuit is coupled to an input of the circumvention device, and wherein outputting via the circumvention device a content or type of rights protection or weakened color stripe protection signal which produces color distortions in the modified color burst of the copy protection signal and extra color distortion due to blanking or modifying of color burst envelopes in an active video field caused by the circumvention device.

It should be noted that such an integrated circuit by default may provide one or more protection or content control signal as previously mentioned when power is applied to the device. In another embodiment of the invention an integrated circuit may produce a partial or no protection or content control signal upon power-up, until a network signal (e.g., Internet Protocol television, WiMax, WiFi, phone, radio frequency, television, digital television, High Definition television, optical, Internet, router signal, signal from a computer, or the like), or transmission, is received in the integrated circuit. Here for example, one or more content or type of rights protection or weakened color stripe protection or content control signal is provided e.g., to provide a more complete or effective protection or content control signal by a video signal upon reception of a signal by the integrated circuit.

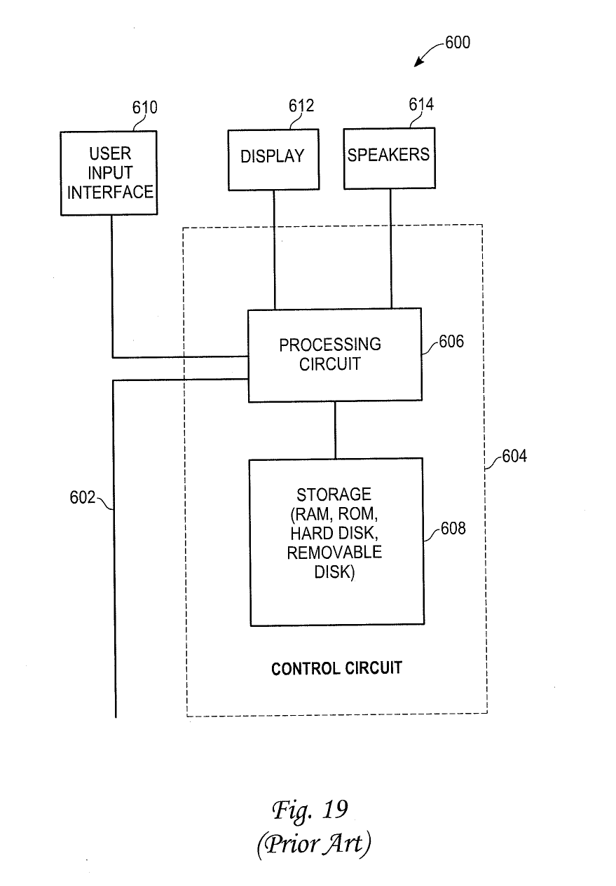

FIG. 19 illustrates an example of a conventional user equipment device 600 that may be used to implement a programming guide or similar media guidance application in accordance with some embodiments. User equipment device 600 may receive and send information from a service provider via input/output (I/O) path 602. I/O path 602 may provide data to control circuit 604, which may include processing circuit 606 and storage 608. I/O path 602 may connect control circuit 604 and specifically processing circuit 606 to one or more communication paths (described below). I/O functions may be provided by one or more of these communication paths, but are shown as a single path in FIG. 19 to simplify the drawing.

Control circuit 604 may be based on any suitable processing circuit 606 such as processing circuit based on one or more microprocessors, microcontrollers, digital signal processors, programmable logic devices, etc. In some embodiments, control circuit 604 executes instructions for a programming guide or any other applications stored in memory, e.g., storage 608. In client-server based embodiments, control circuit 604 may include a communications circuit suitable for communicating with networks or servers. The communications circuit may include a cable modem, an integrated services digital network (ISDN) modem, a digital subscriber line (DSL) modem, a telephone modem, or a wireless modem for communications with other equipment. Such communications may involve the Internet or any other suitable communications networks or paths. In addition, communications circuit may include circuit that enables peer-to-peer communication of user equipment devices, or communication of user equipment devices in locations remote from each other.

Memory, e.g., random-access memory, read-only memory, or any other suitable memory, hard drives, optical drives, or any other suitable fixed or removable storage devices, e.g., DVD recorder, CD recorder, video cassette recorder, or other suitable recording device may be provided as storage 608 that is part of control circuit 604. Storage 608 may include one or more of the above types of storage devices. For example, user equipment device 600 may include a hard drive for a digital video recorder (DVR) (also called a personal video recorder, or PVR) and a DVD recorder as a secondary storage device. Storage 608 may be used to store various types of media and data described herein, including program information, widget settings, user preferences or profile information, or other data. Nonvolatile memory may also be used, e.g., to launch a boot-up routine and other instructions.

Control circuit 604 may include video generating circuit and tuning circuit, such as one or more analog tuners, one or more MPEG-2 decoders or other digital decoding circuit, high-definition tuners, or any other suitable tuning or video circuits or combinations of such circuits. Encoding circuit, e.g., for converting over-the-air, analog, or digital signals to MPEG signals for storage, may also be provided. Control circuit 604 may also include scaler circuit for upconverting and downconverting media into the preferred output format of the user equipment device 600. Circuit 604 may also include digital-to-analog converter circuit and analog-to-digital converter circuit for converting between digital and analog signals. The tuning and encoding circuit may be used by the user equipment to receive and to display, to play, or to record media content. The tuning and encoding circuit may also be used to receive data. The circuit described herein, including for example, the tuning, video generating, encoding, decoding, scaler, and analog/digital circuit, may be implemented by software running on one or more general purpose or specialized processors. Multiple tuners may be provided to handle simultaneous tuning functions (e.g., watch and record functions, picture-in-picture (PIP) functions, multiple-tuner recording, etc). If storage 608 is provided as a separate device from user equipment device 600, the tuning and encoding circuit (including multiple tuners) may be associated with storage 608.

A user may control the control circuit 604 by using user input interface 610. User input interface 610 may be any suitable user interface, such as a remote control, mouse, trackball, keypad, keyboard, touch screen, touch pad, stylus input, joystick, voice recognition interface, or other user input interfaces. Display 612 may be provided as a stand-alone device or integrated with other elements of user equipment device 600. Display 612 may be one or more of a monitor, a television, a liquid crystal display (LCD) for a mobile device, or any other suitable equipment for displaying visual images and display a user controlled cursor or the like. In some embodiments, display 612 may be High Definition television capable. Speakers 614 may be provided as integrated with other elements of user equipment device 600 or may be stand-alone units. The audio component of videos and other media content displayed on display 612 may be played through speakers 614. In some embodiments, the audio may be distributed to a receiver (not shown), which processes and outputs the audio via speakers 614.

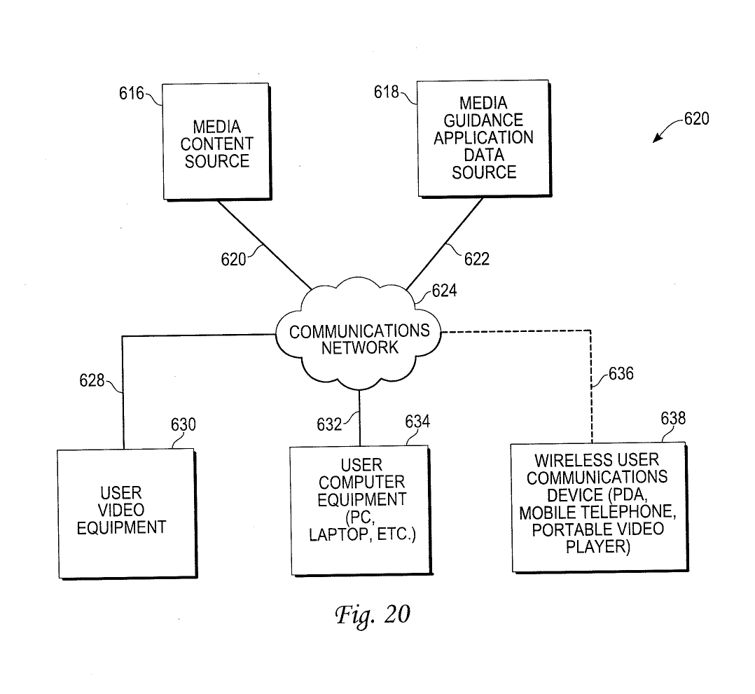

User equipment device 600 of FIG. 19 can be implemented in system 620 of FIG. 20 as user video such as video equipment 630, user computer equipment 634, wireless user communications device 638, or any other type of user equipment suitable for accessing media. For simplicity, these devices may be referred to herein collectively as user equipment or user equipment devices. A user equipment device, on which a media guidance application as explained above may be implemented, may function as a standalone device or may be part of a network of devices. Various network configurations of devices may be implemented and are discussed in more detail below.

User video equipment 630 may be a television set-top box, an integrated receiver decoder (IRD) for handling satellite television, a television set, a digital storage device, a DVD recorder, a video-cassette recorder (VCR), a local media server, or other user video equipment. User computer equipment 634 may include a personal computer (PC), a laptop, a tablet, a Web television box, a personal computer television (PC/television), a PC media server, a PC media center, or other user computer equipment. Wireless user communications device 638 may include a Personal Digital Assistant (PDA), a mobile telephone, a portable video player, a portable music player, a portable gaming machine, or other wireless devices.

Each of user video equipment 630, user computer equipment 634, and wireless user communications device 638 may utilize at least some of the system features described above in connection with FIG. 19.

User equipment devices may be coupled to communications network 620 via communications paths 628, 632, and 636, respectively. Communications network 620 may be one or more networks including the Internet, a mobile phone network, mobile device (e.g., Blackberry) network, cable network, public switched telephone network, or other types of communications network or combinations of communications networks. Path 636 is drawn with dotted lines to indicate it is a wireless path and paths 628 and 632 are drawn as solid lines to indicate they are wired paths.

System 620 includes media content source 616 and media guidance application data source 618 coupled to communications network 624 via communication paths 620 and 622, respectively. Paths 620 and 622 may include any of the communication paths described above.

Media content source 616 may include one or more types of media distribution equipment including a television distribution facility, cable system headend, satellite distribution facility, programming sources (e.g., television broadcasters), intermediate distribution facilities and/or servers, Internet providers, on-demand media servers, print media distributors, radio broadcasters, satellite broadcasters and other media content providers.

Media delivery system 600 may illustrate a number of approaches, or network configurations, by which user equipment devices and sources of media content and guidance data may communicate with each other for the purpose of accessing media and providing media guidance.

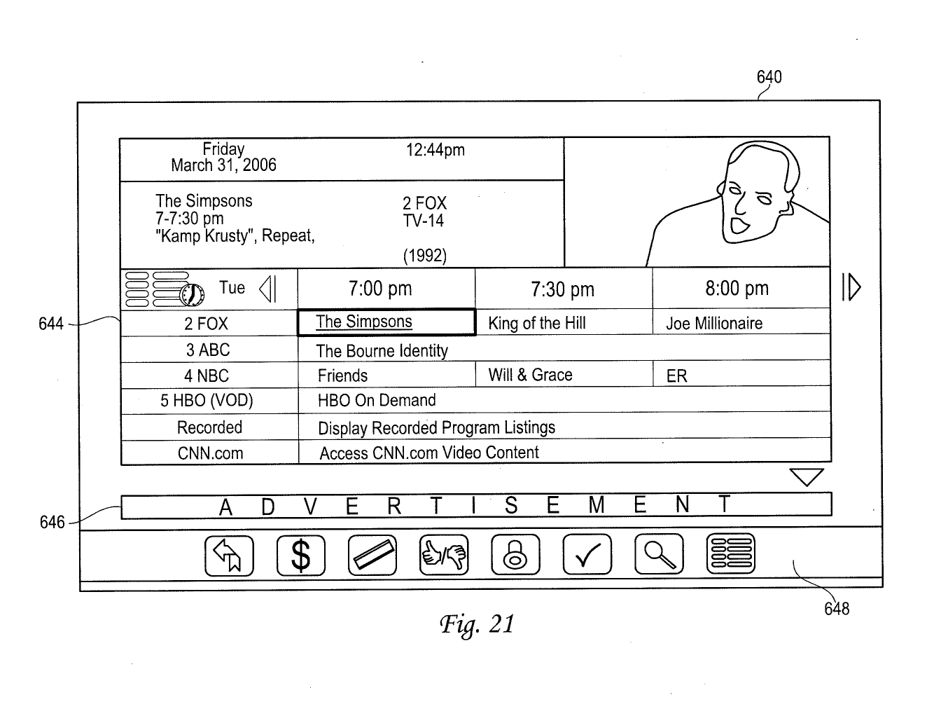

Media guidance applications (e.g., programming guides) may be, for example, stand-alone applications implemented on user equipment devices. In other embodiments, media guidance applications may be client-server applications where only the client resides on the user equipment device. For example, a media guidance application may be implemented partially as a client application on control circuit 604 of user equipment device 600 and partially on a remote server as a server application, e.g., media guidance data source 618. Guidance application displays, e.g., the illustrative screen depicted in FIG. 21, may be generated by media guidance application data source 618 and transmitted to the user equipment devices. Media guidance application data source 618 may also transmit data for storage on the user equipment, which then may generate the guidance application displays based on instructions processed by control circuit.

A media guidance application may be implemented with any suitable architecture. For example, a media guidance application may be a stand-alone application wholly implemented on user equipment device 600. In such an approach, instructions of the application may be stored locally, and data for use by the application may be downloaded on a periodic basis, e.g., from the vertical blanking interval of a television channel, from an out-of-band feed, or by another suitable approach. In another embodiment, the media guidance application may be a client-server based application.

Media guidance applications may be used to provide one or more of media listings, media information, media content, media access and transaction opportunities to users. FIG. 21 depicts an illustrative display screen 640 that may be used to provide media guidance, and in particular media listings (asset identifiers). A user may indicate a desire to access media information by selecting a selectable option provided in display screen 640, e.g., a menu option, a listings option, an icon, a hyperlink, etc., or pressing a dedicated button, e.g., a GUIDE button on a remote control or other user input interface or device. In response to a user's indication, a media guidance application may provide a display screen with media information organized in one of several ways, such as by time and channel (source) in a grid, by time, by channel, by media type, e.g., text, video, audio, by category, e.g., movies, sports, news, children, or other categories of programming, or other predefined, user-defined, or other organization criteria. Such criteria may be specified by the user as part of his information preferences.

The media information and media access account configuration functions of a media guidance application may be interrelated. For example, advertisement 646 of FIG. 21 may provide an advertisement for media content that, depending on a consumer's access configuration and/or media access requests, e.g., for subscription programming, is currently available for viewing, will be available for viewing in the future, may be available for viewing if a user obtains sufficient sponsorship, or may never become available for viewing. Advertisement 646 may correspond to or be unrelated to one or more of the media listings in grid 644.

Options region 648 may allow the user to access different types of media content, media guidance application displays, and/or media guidance application features. Options region 648 may be part of display 640, or may be invoked by a user by selecting an on-screen option or pressing a dedicated or assignable button on a user input device. The selectable options within options region 648 may concern features related to program listings in grid 644 and may include options available from a main menu display.

This disclosure is illustrative and not limiting. Further modifications will be apparent to those skilled in the art in light of this disclosure and are intended to fall within the scope of the appended claims.

We claim:

1. Apparatus for programming, enabling or disabling a content control signal derived from a metadata or a media guidance application data signal, comprising:
a port to receive a metadata or media guidance application data signal from a digital delivery network wherein the received signal includes a trigger, flag or bit pattern signal;
the port coupling the trigger, flag or bit pattern signal to a processing or encoding circuit to provide in response programming, enabling, or disabling a content control signal at an output port of the processing or encoding circuit; and
wherein the content control signal is added or inserted to a video signal to provide a content controlled video signal including a weakened color stripe signal at the output port.

2. The apparatus of claim 1, wherein the media guidance application data signal provides a plurality of identifiers for video assets, each video asset identifier including a title and a source.

3. The apparatus of claim 2, wherein the video asset identifiers are displayed in a grid of a time and the source.

4. The apparatus of claim 3, further comprising manipulating an indicator on the displayed grid to mark one of the video assets.

5. The apparatus of claim 4, further comprising the media guidance application opening to the marked video asset in a single source format.

6. The apparatus of claim 5, wherein the single source format includes rows or columns of sequential video asset identifiers for a source corresponding to the marked video asset.

7. The apparatus of claim 6, further comprising manipulating the indicator to mark a different displayed video asset identifier.

8. The apparatus of claim 1, wherein the media guidance application is utilized for transferring video assets or storing video assets from the apparatus to a storage device.

9. The apparatus of claim 8, wherein the media guidance application displays at least one video asset identifier related to at least one video asset, enabling a user to select a video asset from the displayed video asset identifiers, and storing the selected video asset related to the at least one displayed video asset identifier.

10. A method of controlling a digital video storage device, comprising the acts of:
receiving a digital delivery video signal at a source selector in the digital video storage device;
extracting a media guidance application data signal from the received video signal at the source selector;
deriving a control signal from the extracted signal, wherein the control signal programs a content control signal which includes a weakened color stripe signal; and
providing the weakened color stripe signal in a video signal output from the digital video storage device.

11. A method of providing a content control indication in a video signal output from a video receiver apparatus, comprising the acts of:
receiving a digital video signal or a video file from an external source at a port of the video receiver apparatus;
receiving a command via a media guidance application data signal at the video receiver apparatus;
modifying the received digital video signal or video file at the video receiver apparatus, in response to the received command, to include a weakened color stripe signal in selected scan lines of the video signal or video file, the weakened color stripe signal having an incorrect color burst in a horizontal blanking interval of the selected scan lines, wherein the incorrect color burst is detectable but inadequate to prevent an acceptable video recording of the modified video signal, whereby the weakened color stripe signal is an indication of content control;
converting the modified video signal or video file by a digital to analog converter to an analog video signal; and
outputting the analog video signal from the video receiver apparatus.

12. The method of claim 11, wherein the video receiver apparatus receives the video signal or video file from one of an optical disc, a hard disc, a magnetic tape, or a solid state memory device.

13. The method of claim 11, wherein the output analog video signal conforms to an NTSC, PAL, or SECAM television standard.

14. The method of claim 11, wherein the weakened color stripe signal includes more subcarrier cycles of correct phase angle than subcarrier cycles of incorrect phase angle.

15. The method of claim 11, wherein the weakened color stripe signal includes a plurality of subcarrier cycles of incorrect phase angle that are attenuated.

16. The method of claim 11, wherein the weakened color stripe signal includes at least a first and a second portion, the first portion having subcarrier cycles of correct phase angle and the second portion having subcarrier cycles of incorrect phase angle.

17. The method of claim 11, wherein a length of the weakened color stripe signal is extended beyond the length of a normal color burst.

18. The method of claim 11, further comprising the acts of:
providing a rights protection signal; and
inserting the rights protection signal into the output analog video signal.

19. The method of claim 11, further comprising detecting the command in the received digital video signal or video file.

20. The method of claim 11, wherein a shift from normal of a phase angle of subcarrier cycles in the weakened color stripe signal is at least 20°.

21. The method of claim 11, wherein the weakened color stripe signal encodes one of a plurality of content control states.

22. The method of claim 11, wherein the command is received from a digital video storage medium.

23. The method of claim 11, wherein the command is received from a source external to the apparatus via a digital delivery network.

24. The method of claim 11, wherein the command is metadata.

25. Apparatus to provide a content control indication in a video output signal, comprising:
an input port adapted to receive from an external source a digital video signal or a video file including a media guidance application data signal;
a signal generator coupled to the input port and which generates, for selected video scan lines of the video signal or video file, a weakened color stripe signal having an incorrect color burst for a horizontal blanking interval of the selected scan lines, wherein the incorrect color burst is detectable, but inadequate to prevent acceptable video recording of the modified video signal, and wherein the weakened color stripe signal is combined with the digital video signal or video file;
a digital to analog converter coupled to receive the digital video signal or video file and the weakened color stripe signal; and
an output port coupled to the digital to analog converter for outputting an analog video signal, whereby the weakened color stripe signal in the output analog video signal is an indication of content control.

26. The apparatus of claim 25, further comprising at least one of an optical disc drive, a hard disc drive, a magnetic tape drive, or a solid state memory device and which is coupled to the input port.

27. The apparatus of claim 25, wherein the output analog video signal conforms to an NTSC, PAL, or SECAM television standard.

28. The apparatus of claim 25, wherein the weakened color stripe signal includes more subcarrier cycles of correct phase angle than subcarrier cycles of incorrect phase angle.

29. The apparatus of claim 25, wherein the weakened color stripe signal includes a plurality of subcarrier cycles of incorrect phase angle that are attenuated.

30. The apparatus of claim 25, wherein the weakened color stripe signal includes at least a first and a second portion, the first portion having subcarrier cycles of correct phase angle and the second portion having subcarrier cycles of incorrect phase angle.

31. The apparatus of claim 25, wherein a length of the weakened color stripe signal is extended beyond the length of a normal color burst.

32. The apparatus of claim 25, wherein the signal generator further provides a rights protection signal.

33. The apparatus of claim 25, further comprising:
a control data reader or detector coupled to the signal generator and the input port and which detects a command in the received digital video signal or video file.

34. The apparatus of claim 25, wherein a shift from normal of a phase angle of subcarrier cycles in the weakened color stripe signal is at least 20°.

35. The apparatus of claim 25, wherein the weakened color stripe signal encodes one of a plurality of content control states.

36. The apparatus of claim 25, wherein the signal generator is programmable from an external source via a digital delivery network.

37. The apparatus of claim 25, wherein the signal generator is programmable by a metadata or by a media guidance application data signal.
